(19) United States
(12) Patent Application Publication
(10) Pub. No.: US 2024/0402136 A1
(43) Pub. Date: Dec. 5, 2024

(54) HYBRID LASER/EMAT ULTRASONIC NON-DESTRUCTIVE TEST DEVICE COMPRISING A MONOLITHIC ROTATING OPTICAL ASSEMBLY OF AGILE-BEAM LASER ARRAY TRANSMITTERS GUIDED BY A PLURALITY OF LASER BEAMS FOR TESTING METALLURGICAL OBJECTS

(71) Applicant: STEELEMAT S.À R.L, Luxembourg (LU)

(72) Inventors: Alexey EVDOKIMOV, Moscow (RU); Artemii SUBBOTIN, Odintsovo (RU); Sergii MALYNKA, Dnipro (UA); Georgii SIDOROV, Slavutich (UA)

(21) Appl. No.: 18/689,873

(22) PCT Filed: Aug. 13, 2022
(86) PCT No.: PCT/EP2022/072741

§ 371 Date: Mar. 7, 2024

(51) Int. Cl. G01N 29/24; G01N 29/04; G01N 29/22; G01N 29/265

(52) U.S. Cl. CPC G01N 29/2412; G01N 29/043; G01N 29/225; G01N 29/265; G01N 2291/0234; G01N 2291/106

(57) ABSTRACT

An ultrasonic non-destructive test Device (1) of hybrid electromagnetic acoustic/Laser transducers type comprising a monolithic Rotating Optical Assembly (22) of agile laser array transmitters providing multifocal laser beams guidance by jumps for the control of metallurgical objects (5).

It comprises: a Rotating Shaft (14); an Incoming Laser Source (16), producing an Incoming Laser Beam (18); a monolithic Rotating Optical Assembly (22), equipped with multiple Mirrors (M) which are rigidly linked to it in rotation in perpendicular circles and around the same Rotating Shaft (14); a Drive Motor (24-a); and a set of directional Electromagnetic Acoustic Transducers (34).

It makes it possible to periodically generate a plurality of Secondary Laser Beams (45) and of Deflected Secondary Laser Beams (124) distributed over an Impacts Dotted Line (70) and two parallel Deviated Impacts Dotted Line (130), impacting Rectangular Laser Impact Spots (47, 139, 142) of the Control Area (3).

It detects and qualifies Surface and Sub-surface Discontinuities (12, 13) of Metal Workpieces (5) having any orientations.

A main industrial application is the continuous three-dimensional control of steel slabs during their continuous casting in a steel mill.

### TECHNICAL FIELD

This invention generally relates to ultrasonic non-destructive testing technology (designated by UNDT in English) intended for equipping a metalworking machine tool. It implements a technique involving laser beam work and laser shock processing. Therefore, the invention belongs to the technical class B23K and its subclass 26, according to the international patent classification.

The invention mainly implements a monolithic rotary optical assembly of mirrors of TLAM type (designated by ABLAT in English), to perform agile guidance of multiple outgoing secondary laser beams, issued from the same incoming laser beam, implementing:
a. quality monitoring of metal workpieces, through laser beam focusing (B23K 26/02 and 26/03);
b. automatic focusing of laser beams (B23K 26/04);
c. Laser beam shaping, using multiple focal points (B23K 26/06);
d. optical means for shaping the laser beam, including lenses and mirrors (B23K 26/064);
e. a division of the laser beam into multiple beams, with multiple focal points (B23K 26/067);
f. means for determining the configuration of the laser spot (B23K 26/073);
g. relative movement between the laser beam and the workpiece (B23K
h. a scanning system, involving relative movement between the laser beam and the laser head (B23K 26/082);
i. Laser shock processing (B23K 26/356);
j. a device forming a dotted line of laser impacts on the workpiece (B23K 26/359);
k. auxiliary equipment, and in particular electromagnetic acoustic transducers of the TEMA type (designated by EMAT in English) (B23K 26/70).

The invention generally pertains to a UNDT technology of the hybrid EMATs/Laser type, comprising a TLAM monolithic rotary optical assembly (designated by ABLAT in English), for the control of metallurgical objects,
a. composed of multiple rigidly linked mirrors, arranged according to a helicoid with circular cylindrical screw pitch,
b. rotating cylindrically around a common rotating shaft and,
c. driven by a common drive motor,
d. to perform agile multi-beams lasers guidance.

The technology of the invention also concerns such UNDT hybrid EMATs/Laser device of the type TLAM (designated by ABLAT in English), implementing a technique combining both:
a. emission of ultrasonic mechanical vibrations by laser shock process, using a multitude of distant deviated secondary laser beams impacting the metal workpiece, this in an agile manner by jumps, issued from of same incoming laser beam, and,
b. reception and monitoring of signals induced by ultrasonic mechanical vibrations in the metal workpiece, using a multitude of electromagnetic acoustic transducers of the TEMA type (known as EMAT in English) or equivalents, operating in reception mode.

The main application of the device of the invention is the quality control of the lateral faces of large metallurgical pieces, particularly the upper and lower faces of steel slabs, and of the continuous casting of steel strands in a steel mill.

### BACKGROUND ART

Detection and characterization of defects in metallurgical products are commonly achieved through non-destructive ultrasonic inspection UNDT systems.

One of the UNDT techniques described by the prior art is the CONDU technique (designated CUNDT in English), implementing in particular an electromagnetic acoustic transducer TEMA (known as EMAT in English), and based on a magnetic coupling mechanism. Sound waves are generated within the material, not by contact with the material surface of the products tested. EMATs offer significant advantages over CUNDT piezoelectric transducers. An EMAT can generate, as an emitter and/or receive as a receiver, different modes of ultrasonic waves in conductive materials without physical contact and without using liquid coupling with the tested pieces. Such contactless and couplant-free features improve test reliability. Additionally, the physical properties of the ultrasonic wave transmission path do not change due to contact. Furthermore, the tolerance specifications required for the position and propulsion of metallurgical pieces tested by EMAT transducers are quite loose. This makes EMATs transducers a particularly well-suited solution for industrial applications, such as those involving inspection at medium and elevated temperatures and in poor conditions of the tested metallurgical pieces' surface. An EMAT is known from the state of the art as being a low-efficiency ultrasonic wave emitter, but an effective ultrasonic wave receiver.

A variant of the CUNDT technique, described in the prior art is the EMAT/Laser hybrid technology. Ultrasonic generation is produced by one (or more) pulsed laser(s). And ultrasonic wave detection is carried out by one (or more) electromagnetic acoustic transducer EMAT receivers, which are combined into a hybrid EMAT/Laser ultrasonic technique, for inspecting discontinuities in metallurgical products. The resulting EMAT/Laser hybrid technology is technically contactless. The EMAT is placed in close proximity to the product surface. EMATs can be configured to operate at elevated temperatures. Prior art EMAT/Laser hybrid systems provide a better combination for non-destructive ultrasonic testing of a metallurgical product's surface without contact. One of the main advantages of this EMAT/Laser hybrid technology, aside from being contactless, is its ability to simultaneously detect surface defects (using Rayleigh waves) and sub-surface defects in depth (using longitudinal and transverse waves). The use of a laser emitter, instead of an EMAT emitter, allows for the generation of diverse types of inclined ultrasonic waves at a higher frequency (10 MHz) and with higher intensity than what can be achieved with an EMAT emitter. Additionally, the laser impact of a laser emitter can generate ultrasonic waves at great depth and a considerable distance from the material surface. In contrast, the efficiency of an EMAT emitter significantly decreases with the distance from the material surface and the distance from the discontinuities. Typically, 2 to 3 mm is usually the maximum distance allowed to maintain the efficiency of an EMAT emitter. A first example of this EMAT/Laser hybrid technology is described in the document by Edwards C and al. titled «An Integrated Optical Fibre—EMAT device for application in Ultrasonic NDT» published by the «British Journal of Non-Destructive Testing, Northampton, GB, vol. 32, no. 2, pages 76-78», on Feb. 1, 1990. A second example of this EMAT/Laser hybrid technology is described in the document by Graham G. M. and al. titled «Automated System for Laser ultrasonic sensing of weld penetration» published by «Mechatronics Pergamon Press, Oxford, GB, vol. 7, no. 8, pages 711-721», on Dec. 1, 1997.

According to the UNDT prior art, ultrasonic data of the topology of discontinuities in a product can be digitally processed and displayed in a number of different formats. The most common formats are called A-Scan, B-Scan and C−Scan; or their equivalent topological presentations. Each A-Scan, B-Scan and C−Scan presentation mode offers a different way to view and evaluate discontinuities on and/or within the inspected product material. It is usual to scan and/or display the results of a UNDT test successively in the three presentation formats.

According to the UNDT prior art, when a single ultrasonic receiver is positioned at a point on the surface of the product and is induced by an ultrasonic emitter, the most basic presentation of the shape data of the ultrasonic waves received, seen, and provided by a unique ultrasonic receiver, is in the form of an A-scan displaying the shape of the waves received. In an A-Scan, the amplitude of the echoes and the transit time of the ultrasonic signal from the discontinuities, captured by an EMAT, are plotted on a simple diagram. The vertical axis represents the signal amplitude, and the horizontal axis represents the transit time. Sound energy from the ultrasonic transmitter is induced and propagated through the material via ultrasonic waves. When there is a discontinuity in the product body, part of the energy of wave path is reflected by such a discontinuity reflector toward the ultrasonic receiver. The A-Scan presentation displays the amount of ultrasound energy received as a function of transit time. The relative amount of energy received is plotted along the vertical axis. Elapsed transit time, which is related to the distance travelled through the material, is displayed along the horizontal axis. In A-Scan presentation, the relative size of discontinuities can be estimated by comparing the amplitude of the signal obtained from an unknown discontinuity reflector to that of a know discontinuity reflector.

According to the UNDT prior art, when implementing a linear scan of an object, along a detection line on the surface of an object, belonging to a scan plane crossing it vertically, a B-Scan shows a digitized sectional view of the object according to the scan plane crossing the detection line. A B-Scan combines the multiple A-Scans data provided, (a) either by a single ultrasonic receiver moved in stages following a linear receiver matrix made of successive receiver points along the detection line; or (b) by a multitude of ultrasonic receivers arranged in a fixed manner in distant receiving points of a linear receiving matrix arranged along the detection line; or (c) by a single fixed ultrasonic receiver induced by a multitude of ultrasonic emitters arranged in a fixed manner at distant emitter points, arranged along a pulse line of a linear emitting matrix.

In a B-Scan, the depth of a discontinuity reflector is displayed along the vertical axis. From a B-Scan, the depth of the discontinuity reflectors and their approximate linear dimensions in the direction of the scan line can be determined.

C−Scan presentation is a type of presentation that is possible when a multitude of two-dimensional B-Scans are performed along successive and separate parallel detection (scanning) lines, positioned perpendicular to an axis of the product. A C−Scan is a plan-like view of the three-dimensional location and size of discontinuities. The C−Scan represents a top view of the product parallel to the scanning pattern of the multiple detection lines. The C−Scan presentation provides a 3D view of product discontinuities characteristics that reflect and scatter sound waves on the surface and within the product.

According to the UNDT prior art, it is known to implement an ultrasonic laser pulses' matrix (LEA) on a product, issued from several laser beams. It is also known to implement an ultrasonic EMAT receivers' array (ERA) placed on the product.

It is also known from the UNDT prior art, to combine ultrasonic laser transmitters and EMAT receivers, in a hybrid ultrasonic UNDT device, involving double EMATs/Pulse-Laser matrices, including an ultrasonic laser pulses' array (LEA), and an ultrasonic EMAT receivers' array (ERA).

It is known from the prior art to use a diffractive beam splitter (LBS), to divide (in parallel) an incoming pulsed laser beam and its power into a packet of n secondary outgoing pulsed laser beams, focused in parallel on n distant pulse points belonging to an ultrasonic laser pulses' array (LEA), using a technique called «Beam Splitting». Due to the parallel division, the energy of each pulsed outgoing laser beam is divided by more than n.

An example of this «Beam Splitting» technique is described in U.S. Pat. No. 7,629,555 B2 in the name of Gross et al. This technique is unsuitable for industrial applications for controlling large metallurgical parts, which require a laser pulses' array (LEA) made of high intensity outgoing laser beams.

It is also known from the prior art, to use a continuous beam scanner (LSS), to continuously move an incoming pulsed laser beam into a continuous slice of outgoing pulsed laser beams, focused in a continuously moving manner, but not successively pointwise, along a focusing line passing through possibly n pulse points of an ultrasonic laser pulses' array (LEA). This so-called «Beam Steering» technology generally refers to any continuously variable optical element, including for example moving lenses, variable prisms, variable focal length lenses, deformable mirrors, oscillating mirrors, spatial phase modulators, etc. The most common way to continuously redirect a pulsed incoming laser beam is to reflect it off mirrors or diffract it by holographic gratings mounted on mechanical scanners, such as rotating prisms, oscillating mirror scanners. The classic «Beam Steering» technique is not suitable for efficient industrial UNDT applications. Because the position and therefore the energy of the outgoing pulsed laser beams is diffused in continuous motion towards the material; and unfocused and unconcentrated at distant discrete pulse points.

An example of this «Beam Steering» technique is described in U.S. Pat. No. 4,838,631 in the name of Chande et al. The described device uses a galvanometric mirror to continuously redirect the incoming laser beam towards several optical fibres. The fact of using a galvanometric mirror, which by nature is not rigidly fixed, but oscillates, makes the device very fragile to vibrations. This technology cannot be used effectively in very restrictive, high-vibration environments, such as the metallurgical industry. In addition, «Beam Steering» techniques, and in particular those using a galvanometric mirror, can only produce small angular variations of the incoming laser beam. As a result, the devices of this technique require a large footprint in the direction perpendicular to the plane of impact.

TLAM Matrix Agile Laser Transmitters (designated ABLAT in English) are known from the prior art. The agile focusing by ABLAT of an incoming laser beam consists of diffracting it in a discontinuous manner sequentially and by jumps into a multitude of successive outgoing laser beams angularly distant, in the direction of n dispersed pulse points distant from an ultrasonic laser pulses' array (LEA); rather than directing them in a continuous scanning line. ABLATs are generally used by the prior art in very high technology fields, in laser communications, target acquisition and tracking, laser microscopy and interferometry. The principal areas of application are laser radars, which require the ability to quickly point towards a large number of widely spaced objects; target tracking and discrimination; that of sensors for surveillance, and that of tracking space objects. They are not currently used or known from the prior art for UNDT quality control applications in the metallurgical industry.

The prior art conceptually closest to the invention is described in U.S. Pat. No. 5,948,291 in the name of Neylan et al. The device described comprises an incoming laser beam, and a multitude of n rotating reflector disks, independent of each other, each comprising on their periphery, either a totally reflective fraction (mirror), or a totally transmissive and therefore nonreflective fraction, or a partially transmissive fraction (partial mirror).

The n independent reflector disks of the device are each fixed on n different uncoupled rotary axes. The incoming laser beam is aligned at the base and periphery of the individual rotating reflector disks. The device further comprises a device for selective control of the n different motors, to be able to produce, by differential rotation of the n uncoupled reflector disks, different scenarios of amplitude of the energy of the deflected outgoing laser beams impacting a dotted line of fixed impacts points. The device includes lenses for focusing the outgoing laser beams. But it should be noted that the device described, if it comprises n reflector disks comprising n fractions of rotating mirrors, then it necessarily comprises n different rotating axes of these n independent rotating reflector disks; and n independent means for rotating these n rotary axes; that is to say either n different motors, or either n mechanical rotary coupling devices of the gear type or equivalent.

This described device of the prior art is not of the optical-electromagnetic-acoustic UNDT hybrid EMATs/Laser type. It does not include a sensor assembly, composed of electromagnetic acoustic transducers of the EMAT type or equivalent. It is not intended for quality control of metallurgical parts. And it does not describe the technical means of such a technical result by ABLAT method.

This device of the prior art described can, in certain configurations described, operate in an agile manner like a TLAM (designated by ABLAT in English). But in such an ABLAT type configuration:
a. Its rotating optical assembly, including the n mirrors formed from the totally or partially reflective fractions of its n uncoupled independent reflector disks, is structurally non-monolithic. It is made up of independent optical/mechanical parts, which are not all rigidly mechanically linked, and which are not in fixed position relative to each other. In particular, the n reflector disks, and their n rotating axes rotate relative to each other, and therefore are not fixed relative to each other. The rotating optical assembly therefore has a deformed geometry during rotation. Its rotating optical assembly, made up of n independent rotating reflector disks, is not rigidly fixed on the same rotating shaft.
b. The n mirrors and their n associated reflection points are not in fixed position relative to the same axis of rotation. And they are not put into synchronized rotation by the same drive motor.
c. The n rotating reflector disks are necessarily in a rotating position inclined relative to the overall axis of rotation. Therefore, during the rotation of the rotating optical assembly, the rotating reflection distances of the n reflection points of the n mirrors, perpendicularly and with respect to the main axis of rotation, are all continuously variable.
d. Each of the n reflection points of the n mirrors travels a circle of rotation, centered on the main axis of rotation. This circle of rotation is not perpendicular, but continuously inclined by approximately 45° with respect to the main axis of rotation.
e. The projection of this circle of rotation, parallel to a projection plane parallel to the main axis of rotation and passing through its center of rotation, is formed of an ellipse and not of a segment.
f. The projection of this circle of rotation, parallel to a plane of rotation perpendicular to the main axis of rotation and passing through its center of rotation, is also formed of an ellipse and not of a circle.
g. The virtual reflection cylinder surrounding the n reflection points of the n inclined reflector disks, linked to it, is distorted, and does not have a constant cylinder radius during rotation.
h. The n reflection points of the n independent mirrors of these n reflecting disks are not longitudinally fixed in position, during the rotary movement, but they are in reciprocating longitudinal movement with respect to the main axis of rotation and to the axis of the main laser beam, alternately forwards then backwards.
i. The rotating dotted helical line joining the n reflection points of the n mirrors has an elliptical winding deformed during rotation and not a fixed circular winding. It does not have a circular thread.

The main drawback of this device of the prior art, when used in TLAM mode (designated by ABLAT in English), is that it requires n rotating shafts and n independent means for rotating n these rotating shafts, of motor type or equivalent, to deflect the incoming laser beam into n outgoing laser beams impacting n laser impact points. This induces construction costs, an increase in volume and weight, sensitivity to vibrations, fragility, and risks of breakdowns, substantially proportional to the number of rotating shafts. In addition, this leads to an increase in the vertical bulk of the device which prevents it from being used in industrial applications with reduced available space.

### Technical Problem

It appears from the analysis of the prior art that, due to the above limitations, the hybrid Laser-EMAT UNDT devices suffer in particular from the following disadvantages of A-Scanning and B-Scanning for the UNDT quality control of metallurgical objects, which the invention aims to solve:
a. Hybrid EMATs/Laser UNDT devices of the beam splitting type (designated by «Beam Splitting» in English) are ineffective. Because they lead to a division of the incoming laser power proportional to the number of secondary outgoing beams impacting laser impact points. As a result, they reduce the signal-to-noise ratio and proportionally weaken the resolution of the UNDT control. These devices are therefore unsuitable in industrial UNDT applications, such as the control of metallurgical parts, which require high energy laser shocks.
b. Non-agile hybrid EMATs/Laser UNDT devices of the type with continuous beams movement (designated by «Beam Splitting» in English) are very fragile and sensitive to vibrations. They require a large footprint in the direction perpendicular to the plane of impact. These devices are therefore unusable in industrial UNDT applications such as controlling the underside of a continuous steel strand casting in a steel mill, where vibrations are intense, and where the available vertical space is reduced.
c. The hybrid EMATs/Laser UNDT devices of the prior art, of the agile type and Agile Matrix Laser Transmitters (TLAM) (designated by «Agile-Beam Laser Array Transmitters» or ABLAT in English), have a non-monolithic rotating optical assembly. They require a large number of optical/mechanical parts not linked to each other, and in independent rotational movements. They require a large number of rotating shafts, and a large number of independent means of rotating these rotating shafts, of the motor type or equivalent, which are generally proportional to the number of laser impact points. They are therefore resonant and sensitive to vibrations. They are expensive. Their price is generally proportional to the number of laser impact points. Due to their large number of motors and rotating shafts with axes not collinear with the incoming laser beam, they are bulky in the vertical direction to the Laser impact plane, which is to say in the direction perpendicular to the control zone. In addition, their non-monolithic rotating optical assembly entails risks of dismantling at high rotation speeds; and therefore, entails safety risks of not protecting against high energy laser beams which could be accidentally deflected from their trajectory. So that these devices are neither technically, nor economically, nor in terms of safety, suitable for UNDT control of metallurgical parts in a harsh industrial environment. They are also unusable for industrial applications with reduced available space, such as controlling the lower face of a steel strand casting in a steel mill, in which the lower vertical space available between the support rollers of continuous casting is very limited.

The prior art does not offer any effective, safe, and economical technical solution for configuring a UNDT device to equip a machine tool:
a. which is carrying out continuous scanning of metal parts in a hostile environment, with reduced available space and at an elevated level of vibrations; and, in particular,
b. which is carrying out quality control of large section steel slabs, with a view to the detection and objective characterization of their surface and subsurface discontinuities, during (or after) their continuous casting in steelworks; this,
c. with a single monolithic rotating optical assembly of mechanical and/or optical parts all rigidly linked together, rotating around a single axis of rotation, and,
d. of which the rotating optical assembly is activated by a single drive motor;
e. whose impact points of the secondary laser beams are aligned on several distant dotted impact lines;
f. whose laser impact spots of the secondary laser beams are thin and rectangular; and oriented along different orientation axes, in particular perpendicular; and,
g. whose EMAT acoustic electromagnetic transducers have preferred directional orientations for capturing the induced ultrasonic signals generated by the discontinuities, which are geometrically organized with respect to oriented rectangular laser impact spots, to ensure the detection and qualification of discontinuities of a metal part, having any main orientations of defects, both longitudinal and transverse.

### SUMMARY OF INVENTION

In short, an object of this invention is to provide a new optical-electromagnetic-acoustic UNDT hybrid EMATs/Laser Device, comprising a monolithic Rotating Optical Assembly of the TLAM type (designated by ABLAT in English), providing agile multifocal laser beams guidance, to equip a Machine Tool carrying out quality control of metalworking, on a Control Area of the Surface a Metal Workpiece.

The Device according to the invention is of the type which operates by a combination of:
a. a Shocks Process carried out by laser beams, generating Laser Shocks on the Control Area, inducing Mechanical Vibrations in the Body of the Metal Workpiece, and,
b. a Monitoring, by EMAT Electromagnetic Acoustic Transducers, of the ultrasonic Induced Signals generated by the interaction of Mechanical Vibrations with Surface Discontinuities and Sub-Surface Discontinuities in the Body of the Metal Workpiece, which must be characterized.

The invention relates to a hybrid EMATs/Laser UNDT Device of the specific type described below. The Device includes:
a. a Rotating Shaft;
b. an Incoming Laser Source;
c. a Rotating Optical Assembly;
d. Rotation Means;
e. a monolithic Reflector Assembly; and,
f. a Sensor Assembly.

The Rotating Shaft is capable of rotating around the Rotating Axis. The Incoming Laser Source is equipped with Optical Guidance Means, configured to produce an Incoming Laser Beam with a certain Incoming Laser Power, directed along an Incoming Beam Axis parallel to the Rotation Axis, located at a certain Beam Distance from the Rotation Axis. The Rotating Optical Assembly is configured to rotate about the Rotation Axis. The Rotation Means include a Drive Motor, connected to the Rotating Shaft. It is configured to induce its rotation around the Rotation Axis, with a continuous Direction of Rotation, either continuous clockwise or continuous counterclockwise. The Reflector Assembly is part of the Rotating Optical Assembly. It is composed of a plurality (of at least two) Mirrors acting as an Optical Barrier.

Each of the Mirrors is configured so that, in certain rotating positions of the Rotating Optical Assembly:
a. the Mirror intercepts the Incoming Beam Axis; and,
b. the Mirror presents a Reflection Point (i) positioned at a certain Reflection Distance in a direction perpendicular to the Rotation Axis when rotating and, (ii) to reflect the Incoming Laser Beam impacted on this Mirror (M), (iii) with a change in its Beam Angular Direction, and (iv) with a Reflection Efficiency of the energy of the Incoming Laser Beam substantially equal to one hundred percent.

The Sensor Assembly is composed of a plurality of (at least two) EMAT type Electromagnetic Acoustic Transducers. Their Active Electromagnetic Probe faces the Control Area and is substantially centered on a Detection Point in the Control Area. Each Active Electromagnetic Probe is configured to generate an A-Scan Signal for detecting the position of defects versus time/distance, acquired from the ultrasonic Induced Signals in the vicinity of its Detection Point.

The Device of the invention is of the type comprising a Rotating Optical Assembly configured geometrically such that, when the Drive Motor is activated:
a. The Incoming Laser Beam successively impacts a Reflection Point associated with and belonging to one of its distant Mirrors;
b. Each of the Reflection Points of the Mirrors, travels through a Circle of Rotation, of a certain Radius of Rotation, centered on a Center of Rotation fixed on the Rotation Axis;
c. The different Mirrors redirect in an agile manner; successively and discontinuously the Incoming Laser Beam according to a Secondary Beam Collection, made of a bundle of distant Secondary Laser Beams, resulting from a multitude of successive and discontinuous changes of the Beam Angular Direction of the Incoming Laser Beam, by reflection on the succession of distant and rotating Mirrors.
d. The Rotating Optical Assembly and its Mirrors are geometrically configured in such a way that the Secondary Laser Beams generated successively impact an Impacts Set made up of a multitude of distant Impact Points, located (i) either on the Impact Plane facing the Rotating Optical Assembly, located on the Surface of the Control Area, and near a Detection Point of an EMAT Electromagnetic Acoustic Transducer, (ii) or, on an Auxiliary Mirror.

The Device of the invention is characterized by the differentiating technical combination of the following combined technical characteristics:
a. Its Rotating Optical Assembly, including its Mirrors, their mechanical connection parts, and its associated Reflection Points, in rotation, (i) is monolithic, that is to say made up of mechanical and/or optical parts all rigidly mechanically linked together and in a fixed non-modifiable position relative to each other; (ii) is rigidly fixed by Fixing Means on the same Rotating Shaft; and, (iii) presents a rigid geometry that is nondeformable during its rotation.
b. The Mirrors of the Reflector Assembly and their associated Reflection Points are in fixed position relative to the same Rotation Axis and are set into synchronized rotation by the same Drive Motor.
c. During rotation of the Rotating Optical Assembly by the Drive Motor: (i) The rotating Reflection Distances of the Reflection Points of all Mirrors, taken perpendicular to and with respect to the Rotation Axis, are all continuously equal to each other and substantially equal to the Beam Distance. (ii) Each of the Reflection Points of all the Mirrors travels through a Circle of Rotation, centered on the Rotation Axis, each continuously perpendicular to the Rotation Axis, and, each having a Radius of Rotation, constituted by its Reflection Distance, continuously equal to the Beam Distance. (iii) Each of the Circles of Rotation: presents a projection, in a direction parallel to a projection plane parallel to the Rotation Axis and passing through its Center of Rotation, formed of a Segment of Transverse Cross-Motion, perpendicular to the Rotation Axis and centered on its Center of Rotation; and, presents a projection, in a direction parallel to a plane of rotation perpendicular to the Rotation Axis and passing through its Center of Rotation, formed of a Circle Of Planar Projected Motion which is merged with the Circle of Rotation, and having a Radius of Projected Rotation which is continuously equal to the Beam Distance.

### Solution to Problem

In a simplified and synthetic manner, one of the methods for differentiating, in its minimal form, an EMATs/Laser hybrid optical electromagnetic acoustic UNDT device according to the invention, with respect to other devices of the same type of art prior, is to note the following combined criteria:
a. The Device comprises only one monolithic Rotating Optical Assembly in rotary movement.
b. The Device has only one Rotating Shaft and one Rotation Axis.
c. Its unique Rotating Optical Assembly is monolithic, that is to say it is made up of mechanical and/or optical parts all rigidly linked together.
d. Its unique Rotating Optical Assembly, and all of its mechanical and/or optical parts, is rigidly fixed on the same Rotating Shaft.
e. The Reflection Distances of all Mirrors, in a direction perpendicular to and with respect to the Rotation Axis, are always equal to each other.
f. The Reflection Points of each of its rotating Mirrors each travel a Circle of Rotation, centered on the Rotation Axis, which is continuously perpendicular to the Rotation Axis.
g. The Reflection Points of each of its rotating Mirrors are positioned on a rotating virtual Helical Dotted Line (i) with circular cylindrical screw thread, and (ii) whose longitudinal position is fixed longitudinally with respect to the single Rotating Shaft.
h. All the Mirrors of the Rotating Optical Assembly are driven in synchronized rotation with respect to the single Rotation Axis, using a single Drive Motor.

### BRIEF DESCRIPTION OF DRAWINGS

These and other features, aspects and advantages of the present invention, and other aspects, will be better understood when the following detailed description is read with reference to the accompanying drawings, which illustrate the invention; in which identical characters represent identical parts throughout the drawings.

FIG. 1 is a front view of the device of the invention, in its schematic form.

FIG. 2 is a perspective view of the device of the invention, in its schematic form.

FIG. 3 is a perspective view of the right part of the device of the invention, in its schematic form.

FIG. 4 is a perspective view of the central part of the device of the invention, in its schematic form.

FIG. 5 is a partial perspective view of the device of the invention, in its schematic form, on which appear the circles of rotation, the virtual reflection cylinder and the rotating helical line, on which the rotating mirrors are fixed.

FIG. 6 is a front view of the device of the invention, in its schematic form, on which appear the circles of rotation, the virtual reflection cylinder and the rotating helical line, on which the rotating mirrors are fixed.

FIG. 7 is a partial perspective view of the device of the invention, in its schematic form, on which appear a detail of the virtual reflection cylinder and the rotating helical line, on which the rotating mirrors are fixed in rotation.

FIG. 8 is a partial front view of the device of the invention, showing a detail of the virtual reflection cylinder and the rotating helical line, on which appears the angular inclination of the rotating mirrors.

FIG. 9 is a left view of the device of the invention, in its schematic form.

FIG. 10 is a simplified perspective view of the device of the invention, in a configuration including a monolithic assembly of rotating cylindrical disks on which its rotating mirrors are fixed.

FIG. 11 is a simplified front view of the device of the invention, in a configuration including a monolithic assembly of rotating cylindrical disks on which its rotating mirrors are fixed.

FIG. 12 is a partial perspective view of the device of the invention, where a detail of a configuration appears including a monolithic assembly of rotating cylindrical disks on which its rotating mirrors are fixed.

FIG. 13 is a partial enlarged perspective view of the device of the invention, where a detail of a configuration appears including a monolithic assembly of rotating cylindrical disks on which its rotating mirrors are fixed, and their geometric configurations.

FIG. 14 is a perspective view of the device of the invention, where a configuration appears including a first stiffening assembly, made of upstream hollowed out rigid tubes, arranged in a stiffening cylinder.

FIG. 15 is a perspective view of the device of the invention, where a configuration appears including a first stiffening assembly, made of upstream hollowed out rigid tubes, arranged according to a stiffening cylinder, nested at the periphery of a monolithic assembly of rotating cylindrical disks, on which its rotating mirrors are fixed.

FIG. 16 is a partial perspective view of the device of the invention, where appears an enlarged detail of a configuration including a first stiffening assembly made of upstream hollowed out rigid tubes, arranged according to a stiffening cylinder, nested at the periphery of a monolithic assembly of rotating cylindrical disks, on which its rotating mirrors are fixed.

FIG. 17 a perspective view of the device of the invention, where a configuration appears including a second stiffening assembly, made of downstream hollowed-out rigid tubes, arranged according to a stiffening cylinder.

FIG. 18 is a perspective view of the device of the invention, where a configuration appears including a first stiffening assembly, made of upstream hollowed-out rigid tubes, and a second stiffening assembly, made of downstream hollowed-out rigid tubes, both arranged according to a stiffening cylinder and nested on the periphery of a monolithic assembly of rotating cylindrical disks, on which its rotating mirrors are fixed.

FIG. 19 is a partial magnified perspective view of a detail of the configuration represented at [FIG. 18], where appears the relative positioning of the first and the second stiffening assemblies with respect to the rotating mirrors.

FIG. 20 is a perspective view of the device of the invention, where a configuration appears including a focusing assembly made of focusing lenses.

FIG. 21 is a partial perspective view of the device of the invention, where a configuration appears including a focusing assembly made of cylindrical focusing lenses.

FIG. 22 is a perspective view of the device of the invention, where a configuration appears including a focusing assembly made of cylindrical focusing lenses, and an auxiliary reflector assembly.

FIG. 23 is a partial magnified perspective view showing a detail of the auxiliary reflector assembly of the configuration of the device represented at [FIG. 22].

FIG. 24 is a partial perspective view of the device of the invention, where a configuration appears including a focusing assembly made of cylindrical focusing lenses, and of an auxiliary reflector assembly, showing the geometric configuration of the generated and deflected secondary laser beams.

FIG. 25 is a perspective view of the device of the invention, where a configuration appears including a focusing assembly made of cylindrical focusing lenses, and of an auxiliary reflector assembly, showing the geometric configuration of the generated and deflected secondary laser beams, impacting three parallel laser impacts dotted lines.

FIG. 26 is a perspective view of the device of the invention, where a configuration appears including a focusing assembly made of cylindrical focusing lenses, and of an auxiliary reflector assembly, showing the geometric configuration of the generated and deflected secondary laser beams, impacting three parallel laser impacts dotted lines of longitudinal and transverse rectangular laser impacts.

FIG. 27 is a perspective view of the device of the invention, where a configuration appears including a focusing assembly made of cylindrical focusing lenses, and of an auxiliary reflector assembly, showing the geometric configuration of the generated and deflected secondary laser beams, impacting three parallel laser impacts dotted lines of longitudinal and transverse rectangular laser impacts, and the optimal geometric configuration of directional EMATs to detect longitudinal and transverse defects.

FIG. 28 is a partial perspective view of the device of the invention, where a configuration appears including means for managing the angular position of the rotating mirrors.

FIG. 29 is an overall perspective view of the device of the invention.

FIG. 30 is an overall perspective view of a machine tool equipped with two devices of the invention, to carry out quality control of the upper and lower faces of steel slabs, during or after their continuous casting.

### DESCRIPTION OF EMBODIMENTS

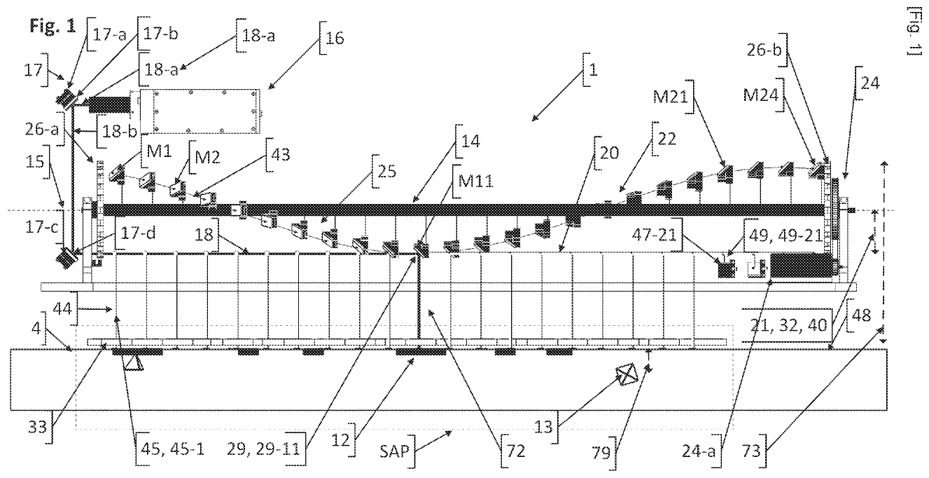

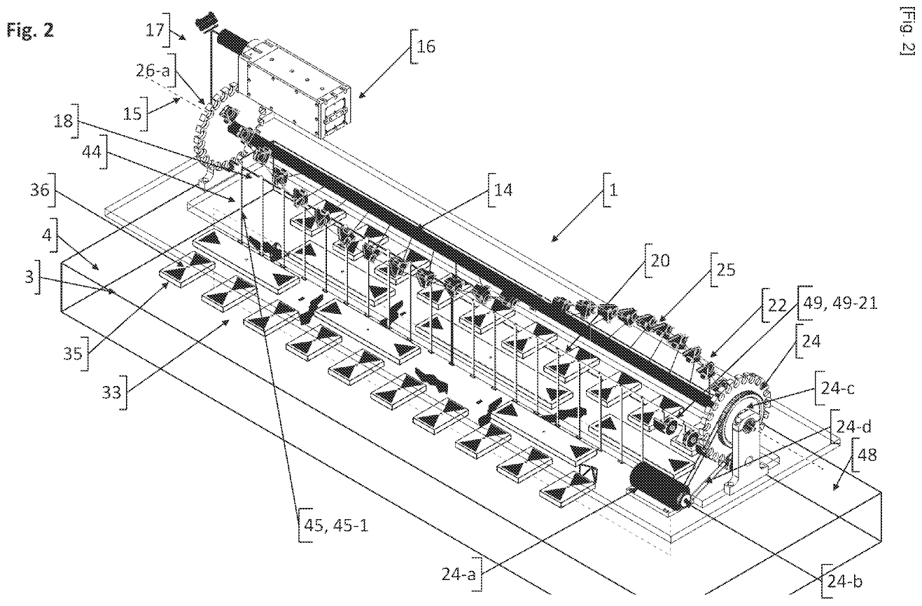

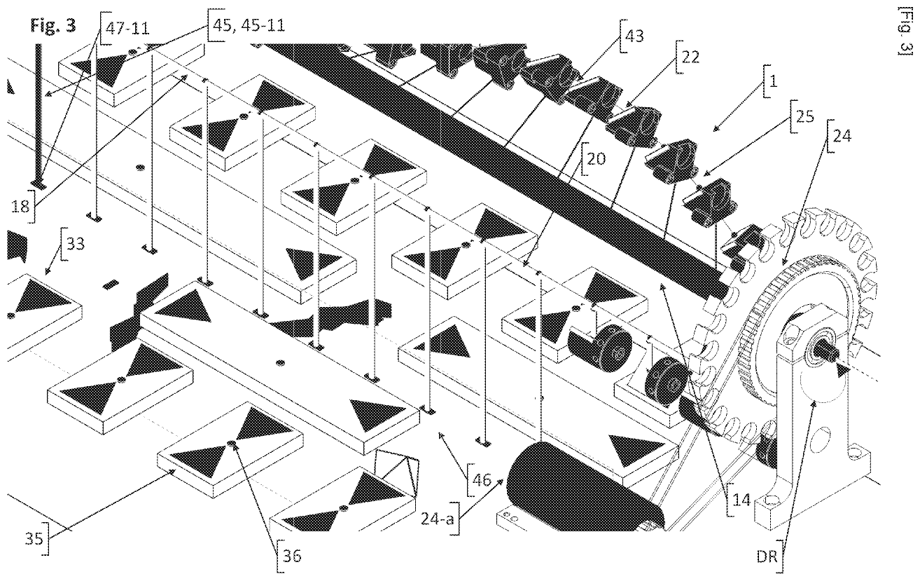

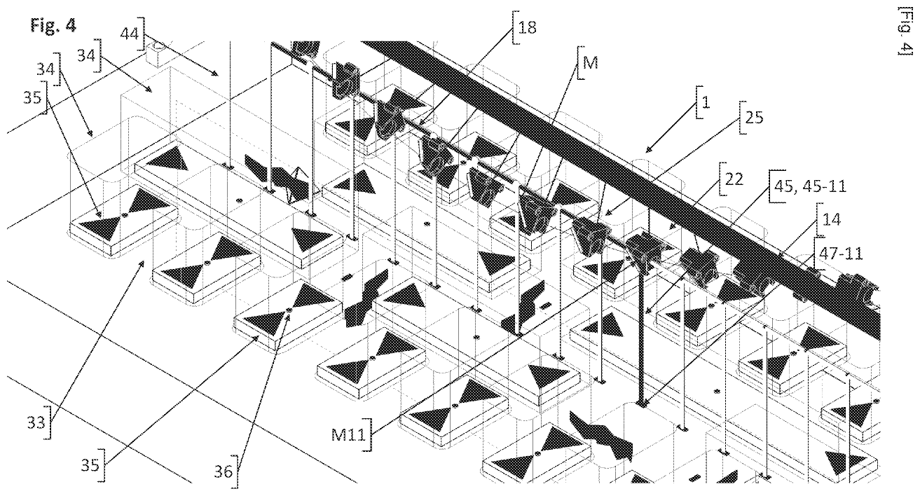

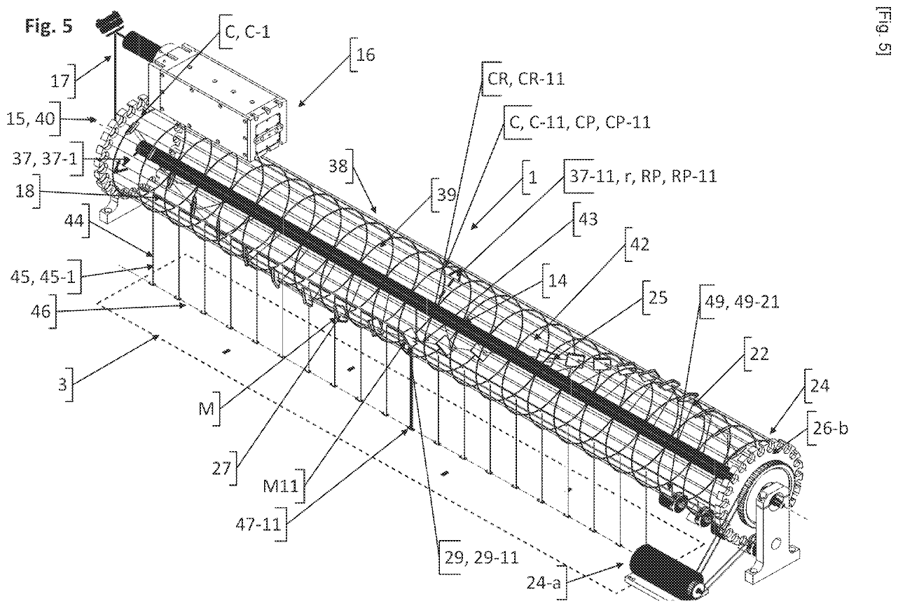

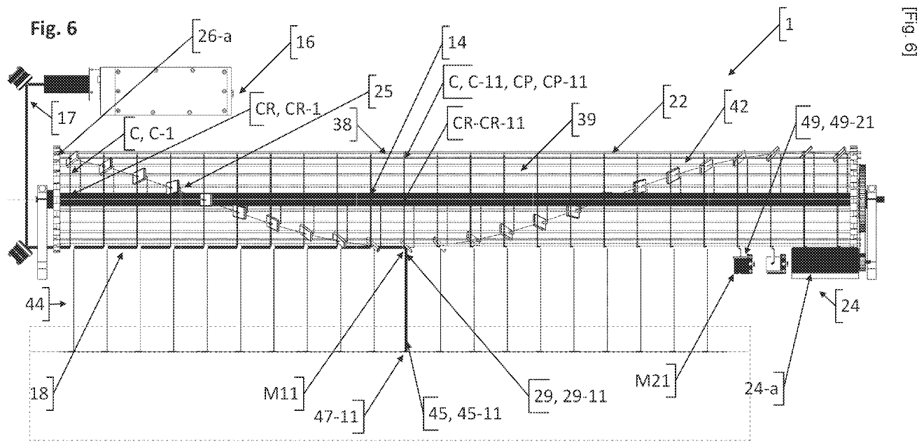

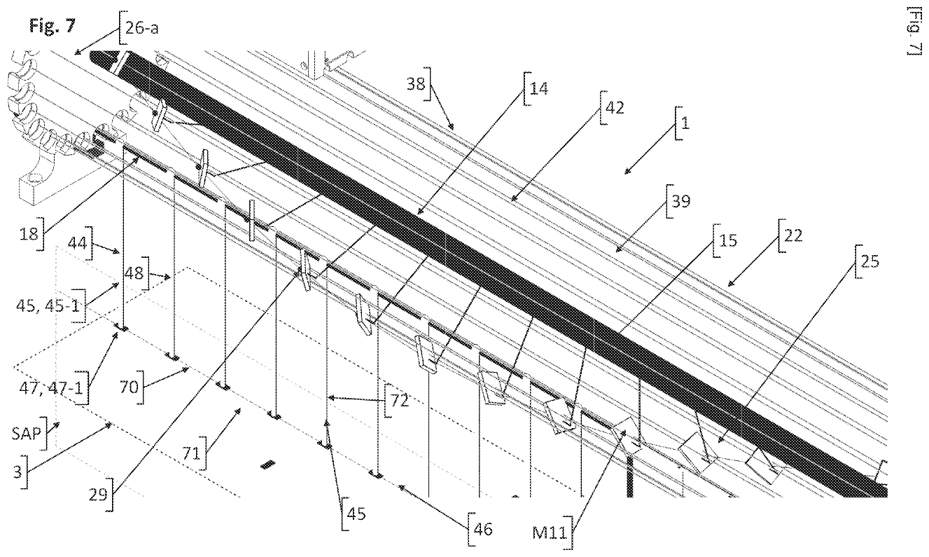

With reference to figures [FIG. 1], [FIG. 2], [FIG. 3], [FIG. 4], [FIG. 5], [FIG. 6], and [FIG. 7], we see a Device (1) of the type optical-electromagnetic-acoustic UNDT hybrid EMATs/Laser, comprising a monolithic Rotating Optical Assembly (22) of the ABLAT type. The Rotating Optical Assembly (22) provides an agile multifocal laser beams guidance, for a Machine Tool (2) carrying out quality control of metal processing, on a Control Area (3) of the Surface (4) of a Metal Workpiece (5).

We see that the Device (1) comprises: a Rotating Shaft (14); an Incoming Laser Source (16); a Rotating Optical Assembly (22); Rotation Means (24) of the Rotating Optical Assembly (22); a Reflector Assembly (25) forming part of the Rotating Optical Assembly (22); and a Sensor Assembly (33).

The Rotating Shaft (14) is capable of rotating around a Rotation Axis (15). The Incoming Laser Source (16) is equipped with Optical Guidance Means (17), configured to produce an Incoming Laser Beam (18), with a certain Incoming Laser Power (PI), directed along the Incoming Beam Axis (20) parallel to the Rotation Axis (15), at a certain Beam Distance (21) from the Rotation Axis (15). The Optical Guidance Means (17) comprise a Primary Angularly Adjustable Reflection Assembly (17-a), equipped with a Primary Angularly Adjustable Mirror (17-b), and a Secondary Angularly Adjustable Reflection Assembly (17-c), equipped with a Secondary Angularly Adjustable Mirror (17-d). The Incoming Laser Source (16) emits a Primary Laser Beam (18-a), reflected at an angle of 90° on the Primary Angularly Adjustable Mirror (17-b), into a Secondary Laser Beam (18-b). The Secondary Laser Beam (18-b) is then reflected at an angle of 90° onto the Secondary Angularly Adjustable Mirror (17-d) and gives rise to the Incoming Laser Beam (18).

The Rotating Optical Assembly (22) is configured to rotate about the Rotation Axis (15). The Rotation Means (24) comprises a Drive Motor (24-a), connected to the Rotating Shaft (14); a Drive Cogwheel (24-b) fixed on the motor shaft; a Rotation Cogwheel (24-c) fixed on the Rotating Shaft (14); and a Belt (24-d) connecting the two cogwheels to transmit the rotary movement. The Drive Motor (24-a) is configured to induce rotation of the Rotating Shaft (14) around the Rotation Axis (15), with a continuous Direction Of Rotation (DR), either continuously clockwise or continuously counterclockwise.

The Reflector Assembly (25) is part of the Rotating Optical Assembly (22). It is composed of a plurality of n=24 Mirrors (M, M1, M2, . . . , M11, M21, . . . , M24) each acting as an Optical Barrier (27). Each of the Mirrors (M) is configured so that, in certain rotating positions of the Rotating Optical Assembly (22), one of the Mirrors (M, M11) intercepts the Incoming Beam Axis (20). Each Mirror (M) has a Reflection Point (29, 29-11) (i) positioned at a certain rotating Reflection Distance (32) perpendicular to the Rotation Axis (15), (ii) to reflect the Incoming Laser Beam (18) impacted on this Mirror (M), (iii) with a change in Beam Angular Direction (A), and (iv) with a Reflection Efficiency (E) of the energy of the Incoming Laser Beam (18) substantially equal to one hundred percent.

The Sensor Assembly (33) is composed of p=25 Electromagnetic-Acoustic Transducers (34) of the EMAT type or equivalent, hereinafter referred to as EMATs. Their Active Electromagnetic Probe (35) faces the Control Area (3). Each Active Electromagnetic Probe (35) is substantially centered on a Detection Point (36) of the Control Area (3). It is configured to generate a A-Scan Signal (AS) for detecting the position of the Defects (12, 13) versus time/distance, acquired from the ultrasonic Induced Signals (11) in the vicinity of its Detection Point (36).

It can be seen that the Rotating Optical Assembly (22) is configured to also present the following technical particularities:
a. When the Drive Motor (24-a) is activated, the Incoming Laser Beam (18) successively impacts one of the 24 Reflection Points (29, 29-11) associated and belonging to one of its 24 distant Mirrors (M, M11).
b. The 24 different Mirrors (M, M1, M2, . . . , M11, M21, . . . , M24) redirect in an agile manner, successively and discontinuously the Incoming Laser Beam (18) according to a Secondary Beam Collection (44), made of a bundle of 24 distant Secondary Laser Beams (45, 45-1, . . . , 45-11 . . . 45-24), resulting from a multitude of 24 successive and discontinuous changes of the Beam Angular Directions (A) of Incoming Laser Beam (18); this by reflection on the succession of 24 distant and rotating Mirrors (M).
c. The Rotating Optical Assembly (22) and its 24 Mirrors (M) are geometrically configured such that when the Drive Motor (24-a) is activated, the 24 Secondary Laser Beams (45, 45-1 . . . , 45-11, . . . , 45-24), generated successively, impact an Impacts Set (46) made of a multitude of n=24 distant Impact Points (47, 47-1 . . . , 47-11 . . . , 47-21, . . . , 47-24). They are located: either (i) for the first 20, on the Impact Plane (48) facing the Rotating Optical Assembly (22), located on the Surface (4) of the Control Area (3), and near a Detection Point (36) of a EMAT type Electromagnetic Acoustic Transducers (34), or (ii) for the following four, on an Auxiliary Mirror (49, 49-21, . . . , 49-24).

We see that the Device (1) presents the following new combination of technical characteristics:
a. Its Rotating Optical Assembly (22) including its 24 Mirrors (M), their mechanical connection parts and its 24 associated Reflection Point (29, 29-11), in rotation, is monolithic. That is to say that it is made up of mechanical and optical parts all rigidly linked together, and in a fixed position in relation to each other which cannot be modified. It is rigidly fixed by Fixing Means (23) on the same Rotating Shaft (14). It has a rigid geometry that is non-deformable during its rotation.
b. The n=24 Mirrors (M) of the Reflector Assembly (25), forming part of the monolithic Rotating Optical Assembly (22), are rigidly linked in relative fixed positions, one with respect to the other, and vis-à-vis the same Rotating Shaft (14).
c. The n=24 Mirrors (M) of the Reflector Assembly (25) and their 24 associated Reflection Points (29, 29-11), are in a fixed position relative to the same single Rotation Axis (15). They are put into synchronized rotation by the same single Drive Motor (24-a).

With reference to figures [FIG. 5] and [FIG. 6], we see that the rotating Reflection Distances (32) of the 24 Reflection Points (29, 29-11) of the 24 Mirrors (M), in a perpendicular direction and with respect to the Rotation Axis (15), are all continuously equal to each other, and substantially equal to the Beam Distance (21). We also see that each of the 24 Reflection Points (29, 29-11) of all the 24 Mirrors (M), travels through a Circle Of Rotation (C, C-1, . . . , C-11, . . . ), centered on the Rotation Axis (15). Each of these 24 Circles Of Rotation (C) is centered on and continuously perpendicular to the Rotation Axis (15). Each of the 24 Circles Of Rotation (C) presents a projection, parallel to a projection plane parallel to the Rotation Axis (15) and passing through its Center Of Rotation (CR, CR-1, . . . , CR-11, . . . ), which is in the form of a Segment of Transverse Cross-Motion (ST, ST-1, . . . , ST-11, . . . ), perpendicular to the Rotation Axis (15) and centered on its Center Of Rotation (CR). In addition, each of these 24 Circles Of Rotation (C) presents a projection, parallel to a plane of rotation perpendicular to the Rotation Axis (15) and passing through its Center Of Rotation (CR, CR-1, . . . , CR-11, . . . ), formed of a Circle Of Planar Projected Motion (CP, CP1, . . . , CP-11, . . . ), confused with the Circle Of Rotation (C), and having a Radius Of Projected Rotation (RP, RP-1, . . . , RP-11, . . . ), continuously equal to the Beam Distance (21).

We see that the Device (1) has the following geometric properties:
a. Each of the 24 Reflection Points (29) of a Mirror (M) is positioned in a fixed manner with respect to the same rotating Cylindrical Reflection Surface (38) of a Virtual Reflection Cylinder (39) of revolution and rotary, rotating around the Rotation Axis (15), with constant circular section. It extends over the entire length of the Rotating Optical Assembly (22), between two lateral circular side Flanks (26-a, 26-b) which are linked to it.
b. The Reflection Cylinder Radius (41) of the Virtual Reflection Cylinder (39) is constant and substantially equal to the Radil Of Rotation (37, 37-1, . . . , 37-11 . . . ) of each of the 24 Circles Of Rotation (C, C-1, . . . , C-11, . . . ), and, to the Beam Distance (21).
c. The cross section of the rotating Virtual Reflection Cylinder (39) and its rotating Cylindrical Reflection Surface (38) is constantly circular.
d. The longitudinal position of the Virtual Reflection Cylinder (39) is fixed with respect to the Rotating Shaft (14), that is to say without any longitudinal movement with respect to the Rotation Axis (15), when the Drive Motor (24-a) is activated.
e. The 24 Reflection Points (29) of each of the 24 Mirrors (M) are positioned on a rotating Helical Dotted Line (43), with circular helical winding, with a radius equal to the Beam Distance (21), and with circular cylindrical screw thread.
f. The Helical Dotted Line (43) is fixed as well as its points on the Cylindrical Reflection Surface (38), and in rotation with it. But its longitudinal position is fixed with respect to the Rotating Shaft (14), that is to say without any longitudinal movement with respect to the Rotation Axis (15), when the Drive Motor (24-a) is activated.
g. When the Drive Motor (24-a) is activated, the Incoming Laser Beam (18) is continuously positioned substantially along 24 successive rectilinear Reflection Generating Lines (42) of the Cylindrical Reflection Surface (38), each attached to a Reflection Point (29) of one of the 24 Mirrors (M). Each Reflection Generating Line moves in rotation with the Virtual Reflection Cylinder (39), but without longitudinal movement with respect to the Rotation Axis (15).

We consider a Cylindrical Coordinate System (CCS), not shown in the figures, and defined as follows. The Polar Cylindrical Axis (52) coincides with the Rotation Axis (15). The Reference Plane (53) is a reference rotation plane perpendicular to the Rotation Axis (15) and intersecting it at a certain reference Point Of Origin (O). Then, the Angular Polar Distances (Dθ) between the Angular Coordinates (0) of two successive Reflection Points (29) of the Helical Dotted Line (43) joining all the Reflection Points (29) and circularly wound, are positive and constant. The Cylindrical Distances (r) of the Reflection Points (29) are constant and all equal to the Beam Distance (21). The circular cylindrical Pitch Of Screw (57) of the Helical Dotted Line (43) is positive and constant.

The constant Angular Polar Distances (Dθ) are approximately equal to 360° divided by the Number Of Mirrors (n=24). Dθ=360°/24=15°. So that in the Cylindrical Coordinate System (CCS), the Overall Reflection Length (Z), consisting of the difference between the Heights (z1, zn) of the two Extremal Mirrors (M1, Mn) furthest from the Rotating Optical Assembly (22), is substantially equal to the Pitch Of Screw (57) of the Helical Dotted Line (43). Thus, the Reflector Assembly (25) presents an Angular Spectrum (AS) of Angular Coordinates (0) covering substantially 360°=24×15°.

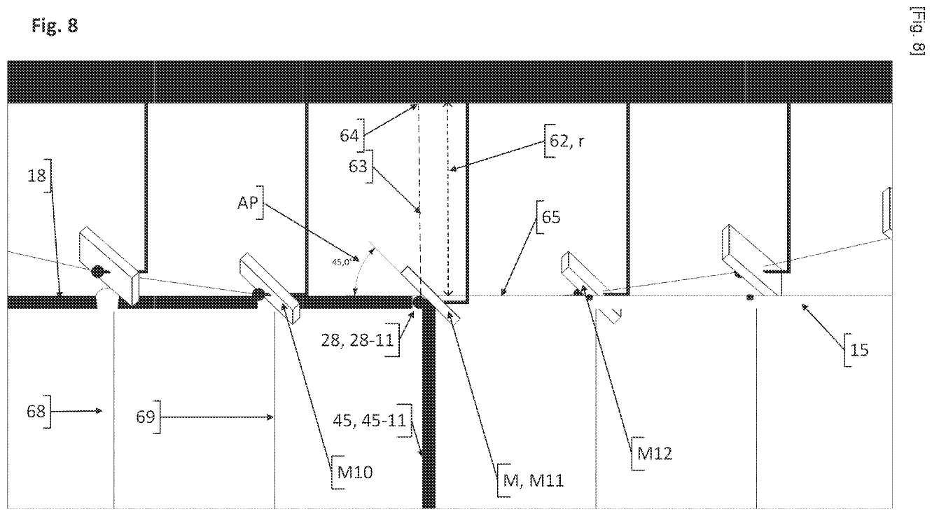

With reference to the figure [FIG. 8], we consider, for each of the 24 Mirrors (M, M11), its Radial Segment (63) joining its Reflection Point (28) to its Projection Point (64) on the Rotation Axis (15). We see that for each Mirror (M, M11), and with respect to its Orientation Plane (65) passing through the Reflection Point (29, 29-11) and perpendicular to the Radial Segment (63); the Radial Segment (63) has a constant Radial Length (62) equal to the Beam Distance (21). The rotating Roll Angle (AR) is zero at 0°. The rotating Pitch Angle (AP) is the same for all 24 Mirrors (M). And the longitudinal position of the Projection Point (64) of each Radial Segment (63) is fixed according to the Rotation Axis (15) and with respect to the Rotating Shaft (14). So that the 24 Secondary Laser Beams (45, 45-11, etc.) are all parallel and arranged according to the same Secondary Beam Plane (68), passing through the Rotation Axis (15) and perpendicular to the Impact Plane (48). And they are arranged according to a Planar Array Of Secondary Beams (69).

In addition, we note that the rotating Pitch Angle (AP) of each Mirror (M) is substantially continuously equal to 45°. And the Control Area (3) and the Impact Plane (48) are parallel to the Rotation Axis (15).

With reference to the figure [FIG. 7], we see that the first 20 Impact Points (47, 47-1) of the Control Area (3). They are separated by a certain Impact Distance (71) between two adjacent Impact Points (47).

With reference to the figure [FIG. 1], we see that the 24 Secondary Laser Beams (45) are each perpendicular to the Impact Plane (48). The Secondary Length (72) of each of the 24 Secondary Laser Beams (45), and therefore the Vertical Dimension (73) of the Rotating Optical Assembly (22) are minimized.

According to a preferred arrangement of the invention, not shown in the figures, the Device (1) is equipped with a digital B-Scan Processor (BSP), connected to the 26 EMAT Electromagnetic-Acoustic Transducers (34). It is configured to process and combine information from their A-Scan Signals (AS) of detection. The B-Scan Processor (BSP) generates a two-dimensional digital B-Scan Presentation (75) of a section of the Metal Workpiece (5), in a B-Scanning Plane (SAP) substantially confused with the vertical Secondary Beams Plane (68), perpendicular to the Impact Plane (48) of the Control Area (3) of the Metal Workpiece (5), substantially along the Detection Line (77) joining the Impacts Dotted Line (70). The B-Scan Presentation (75) represents the Digital Positions (78) with respect to the Depth (79) of the Discontinuities (12, 13) in the B-Scanning Plane (SAP).

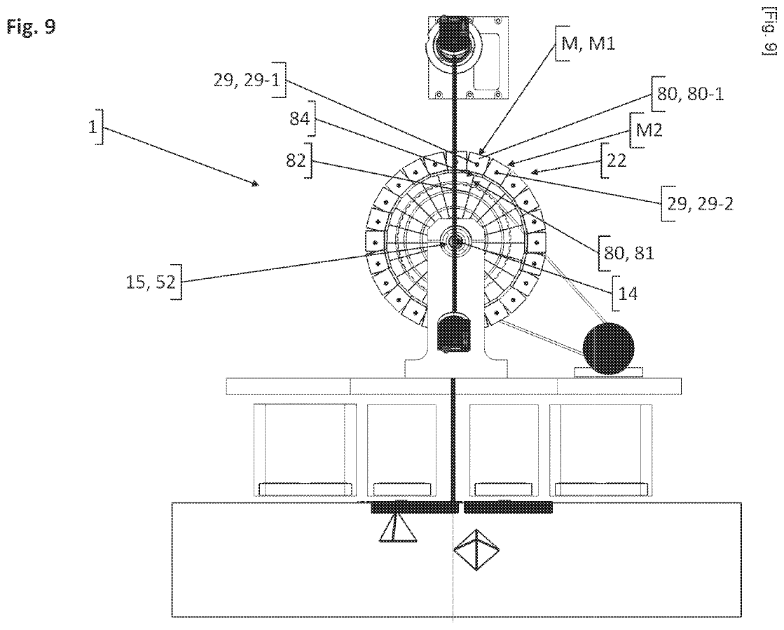

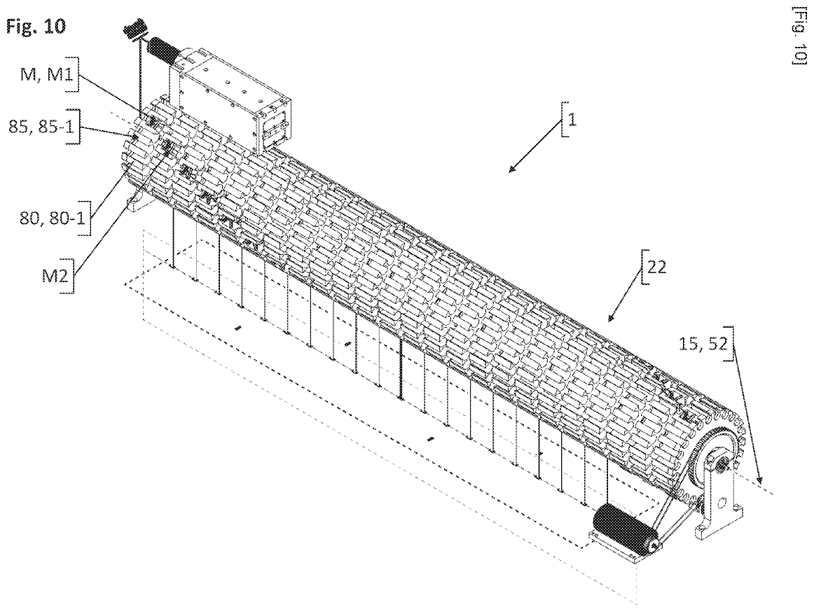

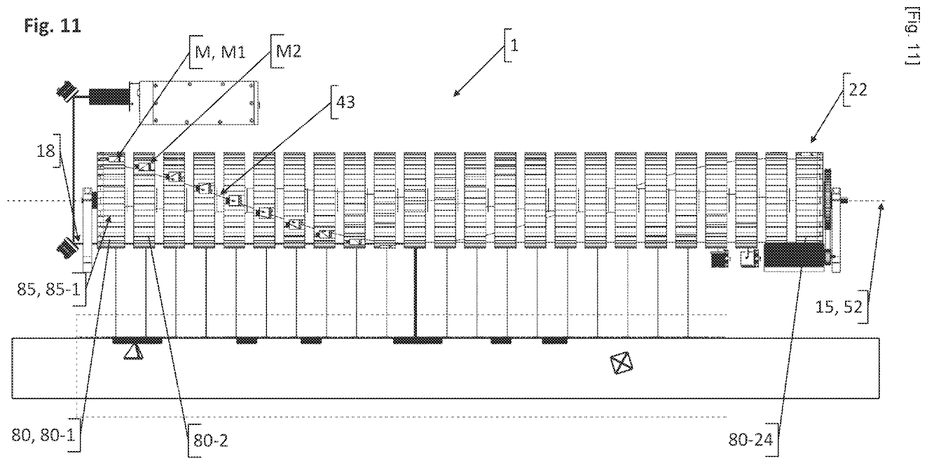

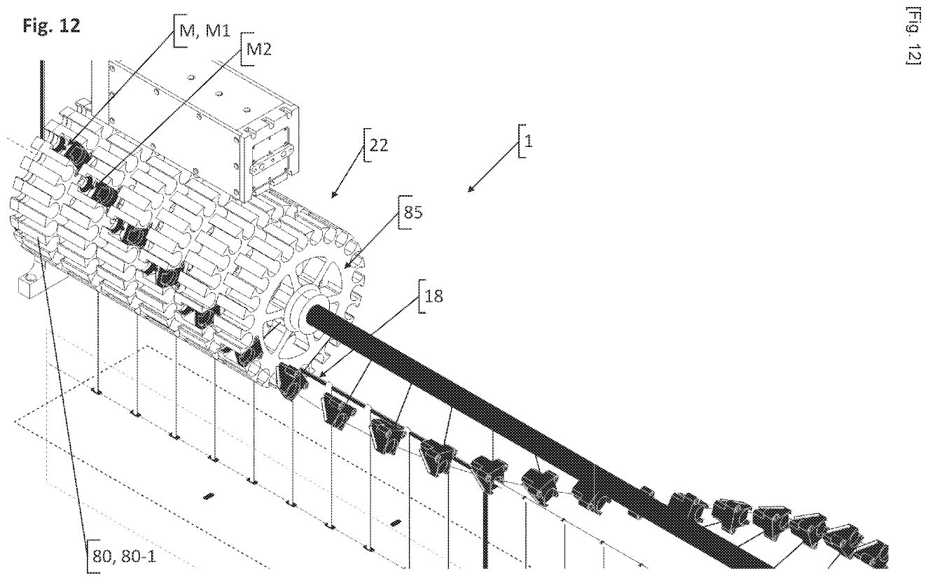

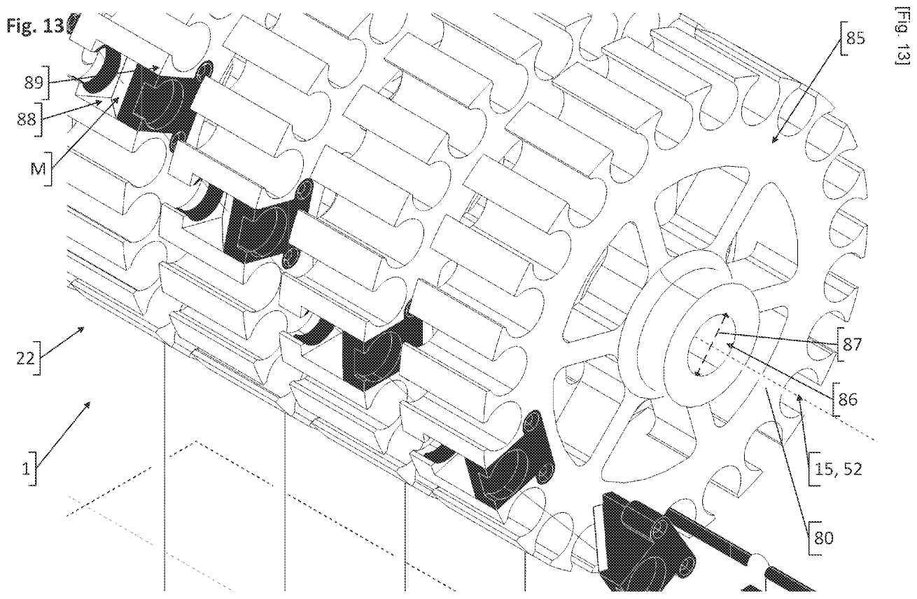

With reference to figures [FIG. 9], [FIG. 10], [FIG. 11], [FIG. 12], and [FIG. 13], we see a configuration preferred by the invention of the Rotating Optical Assembly (22) of the Device (1). The Rotating Optical Assembly (22) is made up of a mechanical assembly of 24 geometrically identical Support Sections (80). They are arranged side by side according to the Rotation Axis (15). A Mirror (M. M1, M2) is attached to each of the 24 Support Sections (80). We see that, in a Cylindrical Coordinate System (CCS), whose Polar Cylindrical Axis (52) coincides with the Rotation Axis (15), two adjacent Support Sections (80, 80-1, 80-24) equipped with their Mirror (M, M1, M2), are in a pivoted position, one relative to the other, perpendicularly to the Rotation Axis (15), of an Angular Polar Distance (Dθ) of 15° between two successive Reflection Points (29, 29-1, 29-2) belonging to their respective Mirrors (M, M1, M-2) of the Helical Dotted Line (43).

With reference to the figure [FIG. 9], we see a first variant of the preferred configuration of the Rotating Optical Assembly (22) of the Device (1). Its 24 Support Sections (80) each have the shape of an elongated Support Beam (81), the Support Axis (82) of which intersects the Rotation Axis (15). Each of the 24 Support Beams (81) is fixed to the Rotating Shaft (14) by a Fixing Means (83). A Mirror (M. M1) is fixed on a Support End (84) of each of the 24 Support Beams (81).

With reference to Figures [FIG. 10], [FIG. 11], [FIG. 12], and [FIG. 13], we see a second variant of the preferred configuration of the Rotating Optical Assembly (22) of the Device (1). Its 24 Support Sections (80) each have the shape of a Support Disc (85, 85-1) of flat cylindrical shape. Each Support Disc (85) is pierced with a Fixing Hole (86), provided perpendicularly and in its center. Its Hole Diameter (87) is substantially equal to the diameter of the Rotating Shaft (14). The 24 Support Discs (85) are embedded side by side on and along the Rotation Axis (15) by their Fixing Hole (86) and positioned along and perpendicularly to the Rotation Axis (15). Each Support Disc (85) is provided with a Support Housing (88), provided on its Disc Periphery (89), on which its Mirror (M) is fixed.

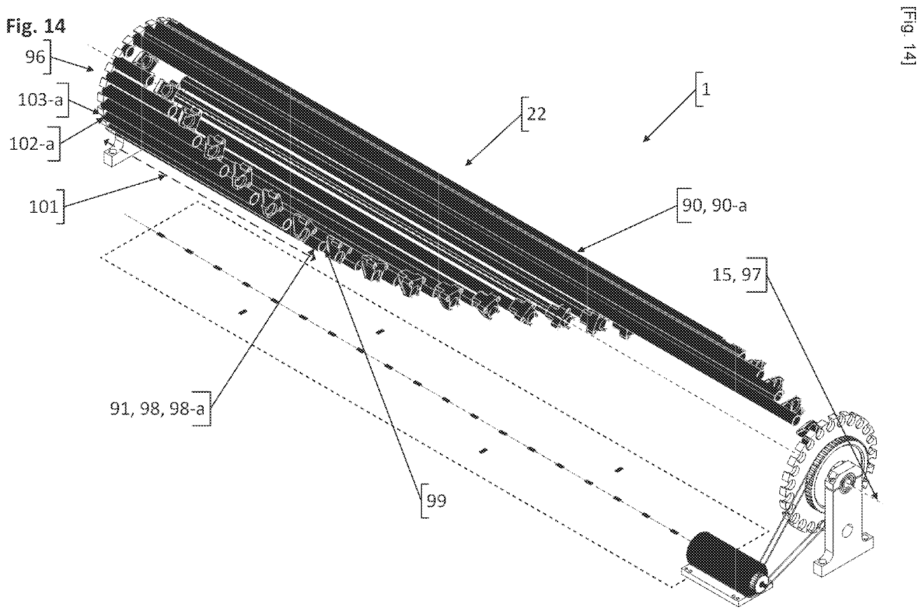

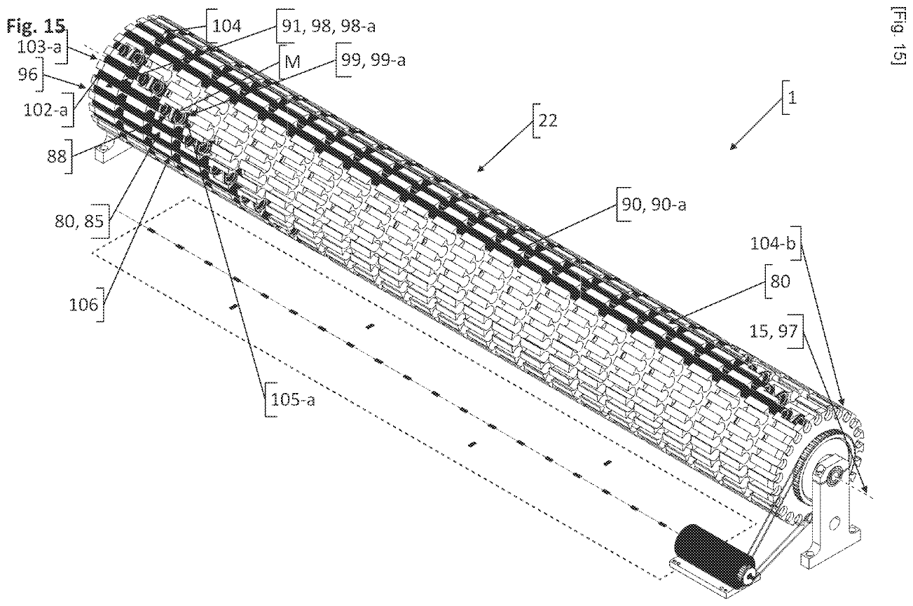

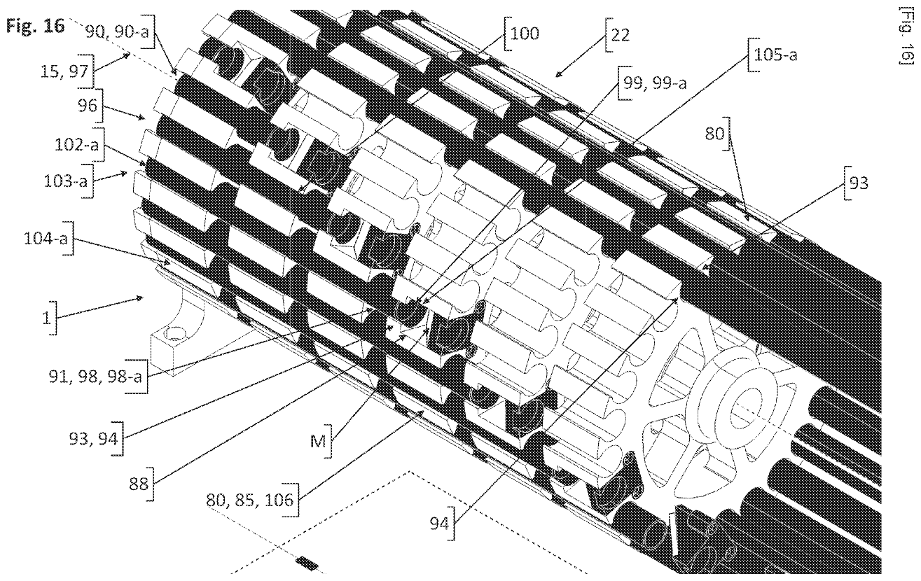

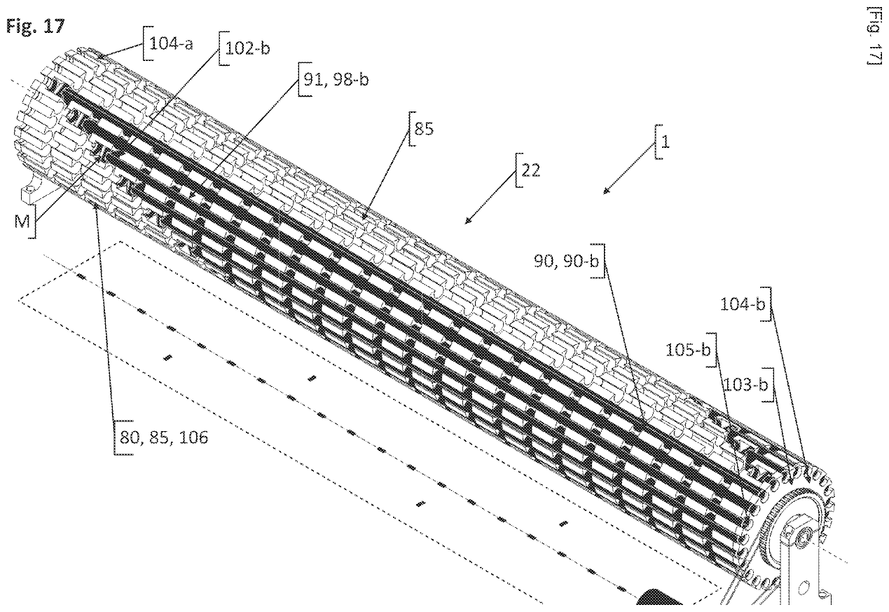

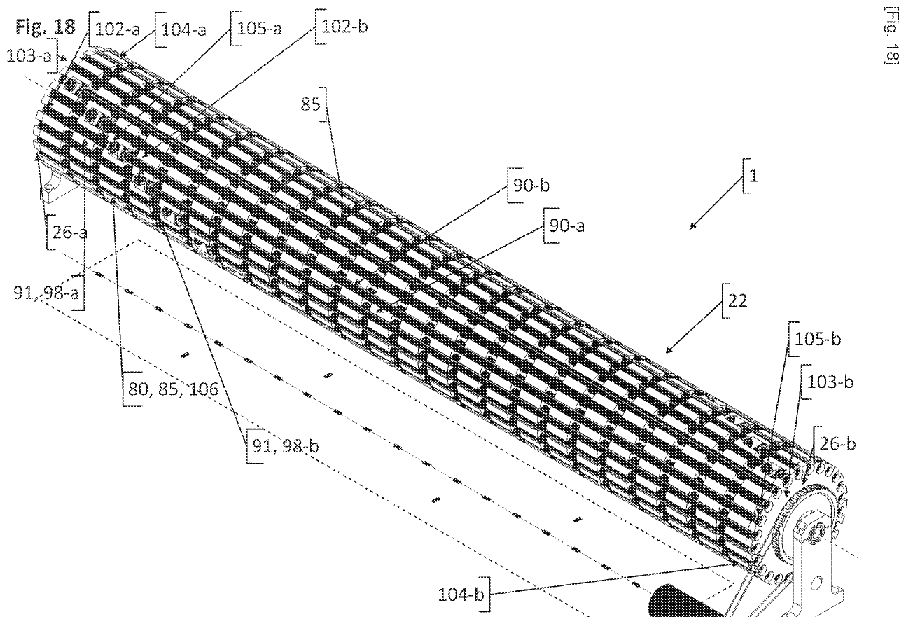

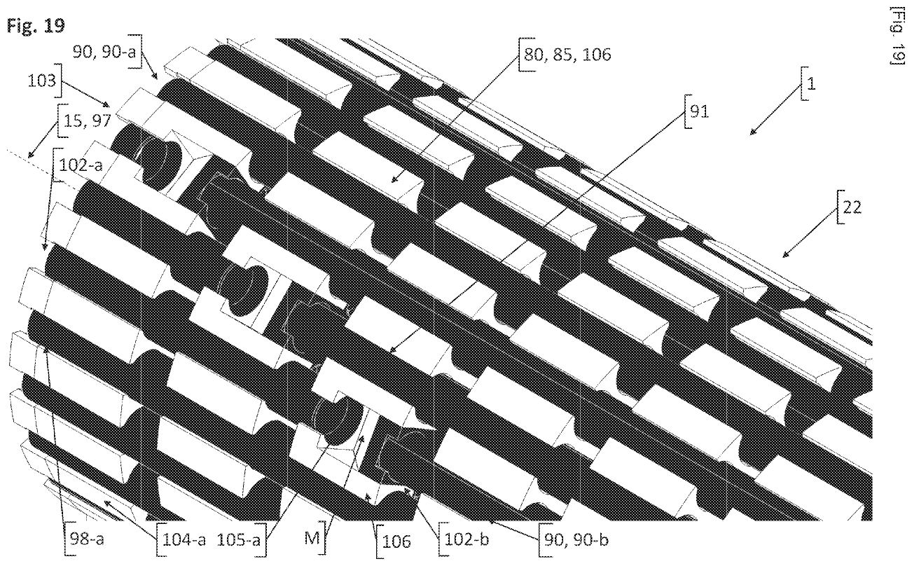

With reference to Figures [FIG. 14], [FIG. 15], [FIG. 16], [FIG. 17], [FIG. 18], and [FIG. 19], we see a complementary configuration arrangement of the Rotating Optical Assembly (22), preferred by the invention. The Rotating Optical Assembly (22) is equipped with a Rigidification Assembly (90, 90-a). It is made up of a plurality of Rigid Rods (91). Their Rigidification Axis (92) is parallel to the Rotation Axis (15). The Rigid Rods (91) are fixed relative to the Rotating Shaft (14), and fixed relative to each other. Each Rigid Rod (91) passes through at least one Support Section (80), to which it is rigidly fixed by a Nesting (93) in a Rigidification Recess (94) of this Support Section (80).

We see that the Rigid Rods (91) are arranged substantially along rectilinear Rigidification Generating Lines (95) of the same Virtual Rigidification Cylinder (96) of revolution. The Rigidification Cylinder Axis (97) of the Virtual Rigidification Cylinder (96) is confused with the Rotation Axis (15).

With reference to Figures [FIG. 15], and [FIG. 16], we see a complementary arrangement of the second preferred configuration variant (described above) of the Rotating Optical Assembly (22). We see that the Rotating Optical Assembly (22) is made up of a mechanical assembly of 24 Support Discs (85), geometrically identical and of flat cylindrical shape. They are arranged side by side, perpendicular and centered in relation to the Rotation Axis (15). Each Support Disc (85) is provided with a Support Housing (88) provided on its Disc Periphery (89), on which its Mirror (M) is fixed. The Rigidification Assembly (90) is formed of Rigid Rods (91), each made up of a rectilinear Rigid Hollowed Tube (98). Each one internally creates an empty Longitudinal Canal (99, 99-a) crossing it from side to side, according to its Rigidification Axis (92). Each Longitudinal Canal (99) is arranged substantially along a rectilinear Rigidification Generating Line (95) of the Virtual Rigidification Cylinder (96). The distance of each Longitudinal Canal (99) with respect to the Rotation Axis (15) is constant, and substantially equal to the Reflection Cylinder Radius (41) and the Beam Distance (21). So that the Virtual Rigidification Cylinder (96) is noticeably confused with the Virtual Reflection Cylinder (39) of revolution. The Rigid Hollowed Tubes (98; 98-a) are embedded in successive Disc Notches (100) provided on the Disc Periphery (89) of some of the 24 Support Discs (85).

With reference to figures [FIG. 14], [FIG. 15], an [FIG. 16], we see that the Rigidification Assembly (90) comprises an Upstream Tubular Rigidification Assembly (90-a), constituted by Upstream Rigid Hollowed Tubes (98-a) which have different Tube Lengths (101). The Upstream Rigid Hollowed Tubes (98-a) are geometrically configured so that they each extend longitudinally between. (i) on the one hand, an Upstream End Of Upstream Tube (102-a), located in the vicinity of the same Upstream Lateral Face (103-a) of the first Upstream Support Disc (104-a) of the Rotating Optical Assembly (22), through which the Incoming Laser Beam (18) penetrates perpendicularly, and (ii) on the other hand, an Downstream End Of Upstream Tube (105-a), placed opposite the Mirror (M) of a variable particular Intermediate Support Disc (106), different for each Upstream Rigid Hollowed Tube (98-a).

We understand that when the Drive Motor (24-a) and the Incoming Laser Source (16) are activated:
a. The Rigidification Axes (92) of the Upstream Rigid Hollowed Tubes (98-a) are in rotation and confused with rectilinear Reflection Generating Lines (42) of the Virtual Reflection Cylinder (39) of revolution.
b. The Incoming Laser Beam (18) successively penetrates through the Longitudinal Canal (99, 99-a) of one of the successive Upstream Rigid Hollowed Tubes (98-a) and successively impacts the Reflection Point (29) of a Mirror (M) of one of the particular Intermediate Support Disc (106) facing it.
c. The Upstream Tubular Rigidification Assembly (90-a) concomitantly ensures (i) stiffening and immunization to longitudinal vibrations of the Rotating Optical Assembly (22), and (ii) safety protection by encapsulation of the Incoming Laser Beam (18) during the rotation of the Rotating Optical Assembly (22).

With reference to Figures [FIG. 17], and [FIG. 18], we see that the Rigidification Assembly (90) also includes a Downstream Tubular Rigidification Assembly (90-b) constituted by Downstream Rigid Hollowed Tubes (98-b) which have different Tube Lengths (101). The Downstream Rigid Hollowed Tubes (98-b) are geometrically configured so that they each extend longitudinally between, (i) on the one hand, an Upstream End Of Downstream Tube (102-b), arranged behind the Mirror (M) of a particular Intermediate Support Disc (106), different for each Downstream Rigid Hollowed Tube (98-b); and, (ii) on the other hand, by a Downstream End Of Downstream Tube (105-b), located in the vicinity of the same Downstream Lateral Face (103-b) of the last Downstream Support Disc (104-b) of the Rotating Optical Assembly (22). We see that the 24 Upstream Rigid Hollowed Tubes (98-a) are nested in Disc Notches (100), spaced angularly at 15° of the periphery of the upstream Flank (26-a). Likewise, the 24 Downstream Rigid Hollowed Tubes (98-b) are fitted into Disc Notches (100), spaced angularly at 15° of the periphery of the downstream Flank (26-b). This allows precise angular indexing during assembly.

We understand that:
a. The Upstream Tubular Rigidification Assembly (90-a) and the Downstream Tubular Rigidification Assembly (90-b) have a similar topology. And they are complementary. They are essentially the image of each other after a mirror reflection combined with an axial rotation of 180°.
b. The combination of the Upstream Tubular Rigidification Assembly (90-a) and the Downstream Tubular Rigidification Assembly (90-b), (i) ensures stiffening and immunity to longitudinal vibrations of the Rotating Optical Assembly (22), over its entire length during its rotation, and (ii) serves as a guide to allow easy and precise assembly and angular indexing of the Support Discs (85), in combination with the lateral Flanks (26-a, 26-b).
c. The Downstream-Rigid Hollowed Tubes (98-b) are never penetrated by the Incoming Laser Beam (18).

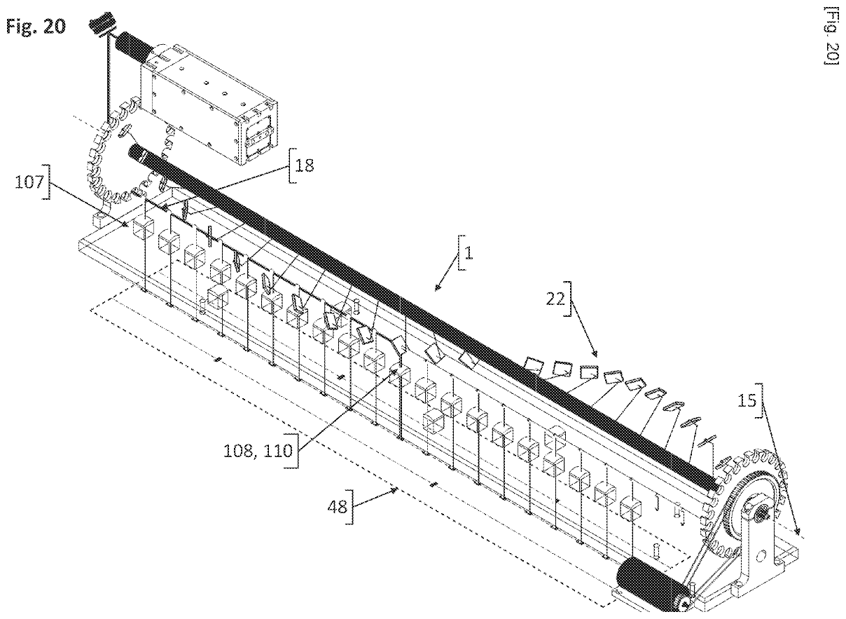

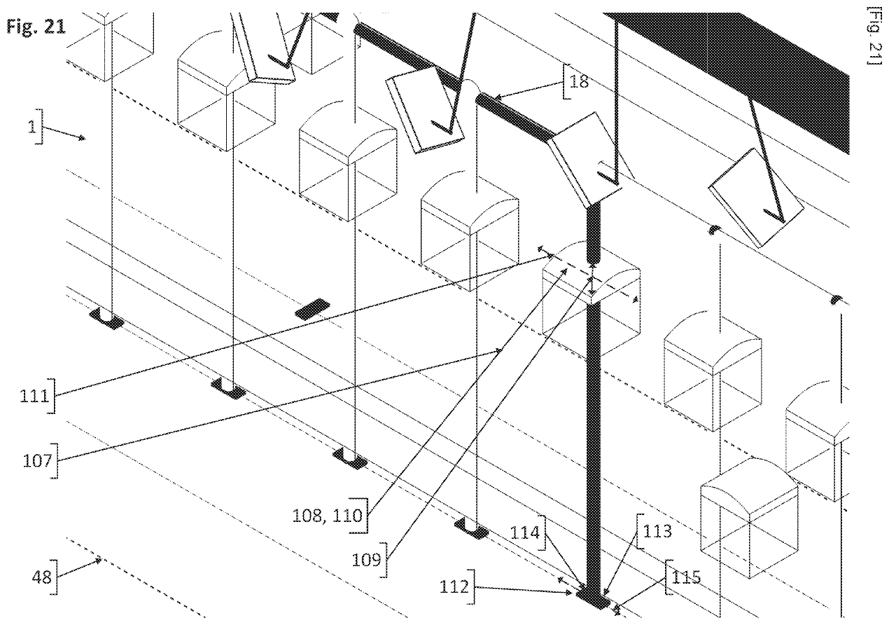

With reference to the figures [FIG. 20] and [FIG. 21], we see a third preferred variant of configuration of the Device (1) of the invention. The Device (1) is equipped with a Focusing Assembly (107), consisting of Focusing Lenses (108), fixed with respect to the Rotation Axis (15) and the Impact Plane (48). These Focusing Lenses (108) are positioned between the Rotating Optical Assembly (22) and the Impact Plane (48). Their Optical Axis (109) is perpendicular to the Impact Plane (48).

It is further seen that the Focusing Assembly (107) is equipped with Cylindrical Focusing Lenses (110). According to the invention, these Cylindrical Focusing Lenses (110) can be of cylindrical or semi-cylindrical type. In the case shown, these are semi-cylindrical type lenses. They have an Optical Cylinder Axis (111) substantially parallel to the Impact Plane (48).

It can be seen that the Cylindrical Focusing Lenses (110) are configured to focus the Secondary Laser Beams (45) passing through them, according to a narrow Rectangular Laser Impact Spot (112). That is to say, its Laser Spot Length (113) is at least twice its Laser Spot Width (114). So that this thus defines a Rectangular Spot Axis (115) oriented according to the Laser Spot Length (113).

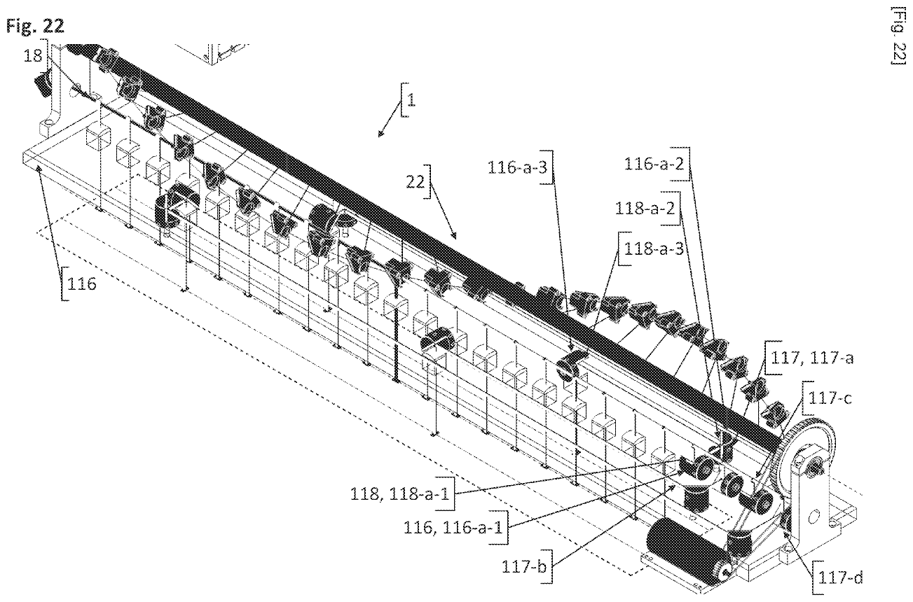

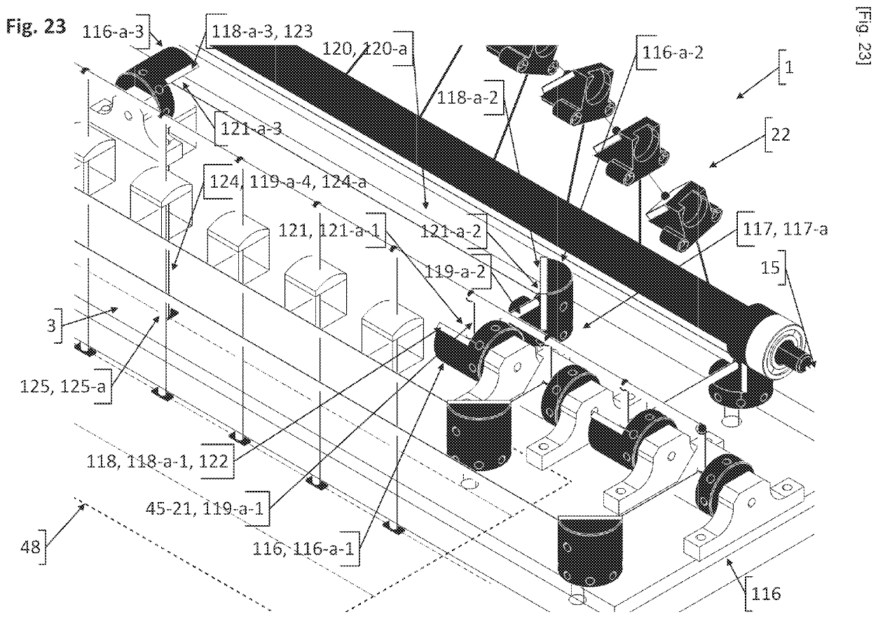

With reference to the figures [FIG. 22] and [FIG. 23], we see a fourth preferred variant of configuration of the Device (1) of the invention. The Device (1) comprises a Secondary Support (116), in a fixed position with respect to the Rotation Axis (15) and the Impact Plane (48). We see that the Device (1) includes four Auxiliary Reflector Assemblies (117, 117-a, 117-b, 117-c, 117-d). The first Auxiliary Reflector Assembly (117, 117-a) is composed of (q=3) Auxiliary Mirrors (118, 118-a-1, 118-a-2, 118-a-3). The Auxiliary Mirrors (118) are each glued to an Auxiliary Mirror Support (116-a-1, 116-a-2, 116-a-3); with adjustable angular orientation in pitch and yaw. Each Auxiliary Mirror Support (116-a-1, 116-a-2, 116-a-3) is fixed on the Secondary Support (116). So that all the Auxiliary Mirrors (118) are each in a fixed position between them and vis-à-vis the Secondary Support (116). The Auxiliary Mirrors (118, 118-a-1, 118-a-2, 118-a-3) are positioned and configured geometrically to deflect, by successive reflections, the Auxiliary Laser Beams (119, 119-a-1, 119-a-2, 119-a-3, 119-a-4) belonging to a Auxiliary Beams Collection (120, 120-a, 120-b, 120-c, 120-d), the first deflected beam (119-a-1) of which is made up of one of the last four Secondary Laser Beams (45, 45-21) emitted by the Rotating Optical Assembly (22).

The Auxiliary Mirrors (118, 118-a-1, 118-a-2, 118-a-3) are each successively impacted by one of the Auxiliary Laser Beams (119, 119-a-1, 119-a-2, 119-a-3) previously impacting in a Auxiliary Reflection Point (121, 121-a-1, 121-a-2, 121-a-3) of this Auxiliary Mirror (118, 118-a-1, 118-a-2, 118-a-3), following each time a change in Beam Angular Direction (A) of the previously impacting Auxiliary Laser Beam (119, 119-a-1, 119-a-2, 119-a-3).

An Upstream Auxiliary Mirror (122, 118-a-1) of the Auxiliary Reflector Assembly (117, 117-a) is positioned on the path of a Secondary Laser Beam (45, 45-21). The Upstream Auxiliary Mirror (122,118-a-1) is geometrically configured, to be impacted by this Secondary Laser Beam (45, 45-21) on its Auxiliary Reflection Point (121, 121-a-1), and to reflect a first Auxiliary Laser Beam (119, 119-a-2) deviated from the Auxiliary Beams Collection (120, 120-a).

A Downstream Auxiliary Mirror (123, 118-a-3) of the Auxiliary Reflector Assembly (117, 117-a) is geometrically configured to face substantially both (i) the last Auxiliary Laser Beam (119, 119-a-3) previously deviated of the Auxiliary Beams Collection (120, 120-a), and (ii) the Control Area (3). The Downstream Auxiliary Mirror (123, 118-a-3) deflects this last previously deviated Auxiliary Laser Beam (119, 119-a-3) according to a final Deflected Secondary Laser Beam (124, 119-a-4, 124-a), which impacts, downstream of the Auxiliary Beams Collection (120, 120-a), a Deviated Impact Point (125, 125-a) of the Impact Plane (48) of the Control Area (3), neighboring a Detection Point (36) of an EMAT type Electromagnetic-Acoustic Transducer (34).

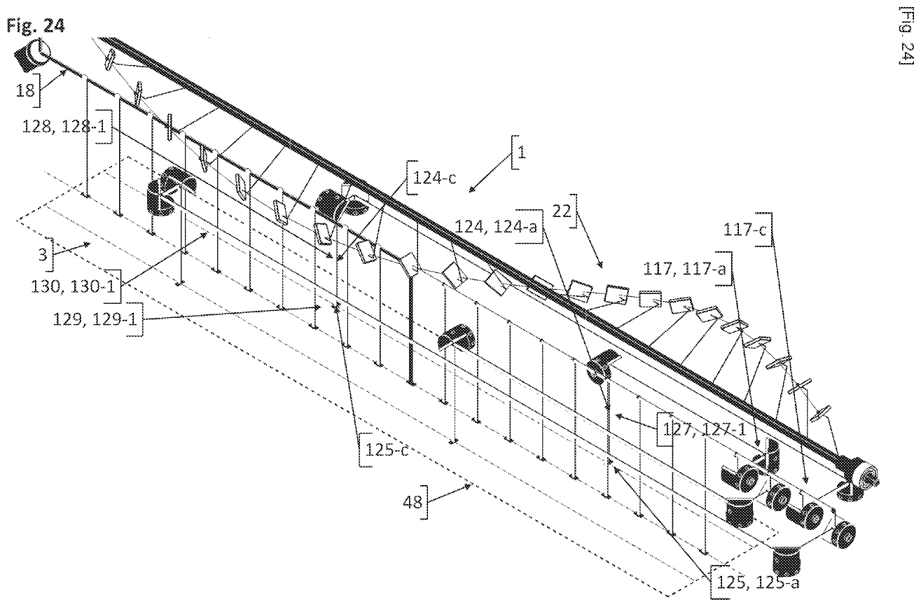

With reference to the figure [FIG. 24], we see a first complementary arrangement of the fourth variant of preferred configuration of the Device (1) described above. The Device (1) is equipped with an Auxiliary Reflector Assembly (126, 126-1), consisting of two Auxiliary Reflector Assemblies (117, 117-a, 117-c). These two Auxiliary Reflector Assemblies (117, 117-a, 117-c) are geometrically configured such that their at least two Deflected Secondary Laser Beams (124, 124-a, 124-c) are parallel and arranged according to the same Deviated Secondary Beams Plane (127, 127-1) substantially perpendicular to the Impact Plane (48). They are arranged according to a Deflected Planar Array Of Secondary Beams (128, 128-1). They impact a Deviated Impacts Set (129, 129-1) made of at least two distant Deviated Impact Points (125, 125-a, 125-c), arranged on a rectilinear Deviated Impacts Dotted Line (130, 130-1) of the Impact Plane (48) of the Control Area (3).

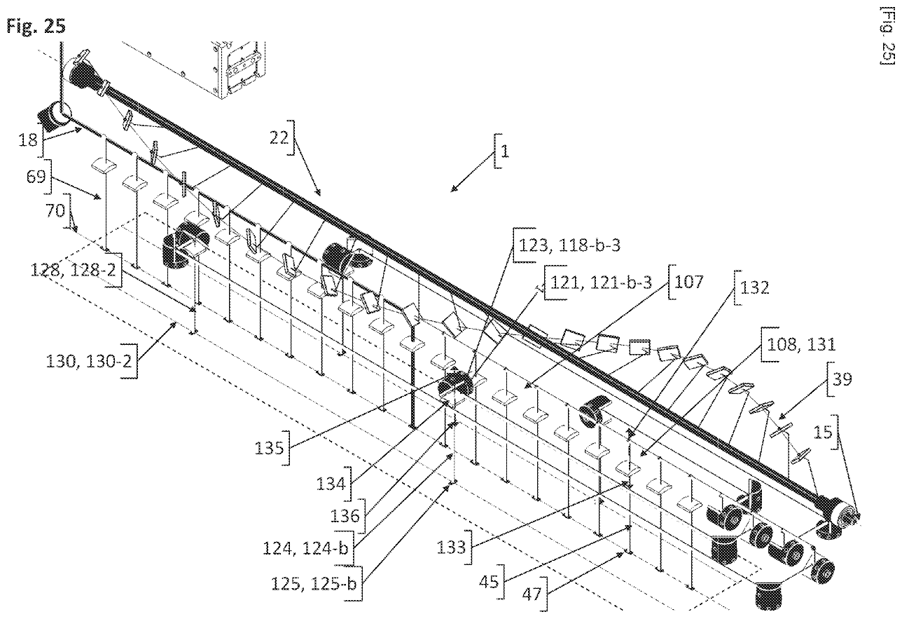

With reference to the figure [FIG. 25], we see that the Device (1) is equipped with a Focusing Assembly (107) made up of Focusing Lenses (108), positioned in a fixed manner vis-à-vis the Rotation Axis (15) and Impact Plane (48). These Focusing Lenses (108) are geometrically configured in two groups, according to the positioning of their Optical Axes (109). A first group is made up of Secondary Focusing Lenses (131) whose Secondary Optical Axis (132) is confused with the Secondary Axis (133) of a Secondary Laser Beam (45), issued from the Reflection Point (29) of a rotating Mirror (M). And in this case, the Secondary Focusing Lens (131) is fixed opposite the Rotation Axis (15), between the Virtual Reflection Cylinder (39) of revolution and the Impact Point (47) of this Secondary Laser Beam (45). It is configured to focus this Secondary Laser Beam (45) on its Impact Point (47) of the main Impacts Dotted Line (70). A second group is made up of Auxiliary Focusing Lenses (134), whose Auxiliary Optical Axis (135) is confused with the Auxiliary Axis (136) of a final Deflected Secondary Laser Beam (124), coming from the final Auxiliary Reflection Point (121, 121-b-3) of a Downstream Auxiliary Mirror (123, 118-b-3). And in this case, the Secondary Focusing Lens (131) is fixed opposite the Rotation Axis (15), between the Virtual Reflection Cylinder (39) of revolution and the Deviated Impact Point (125, 125-b) of the Deflected Secondary Laser Beam (124, 124-b). It is configured to focus this Deflected Secondary Laser Beam (124, 124-b) on its Deviated Impact Point (125, 125-b) of an auxiliary Deviated Impacts Dotted Line (130, 130-2).

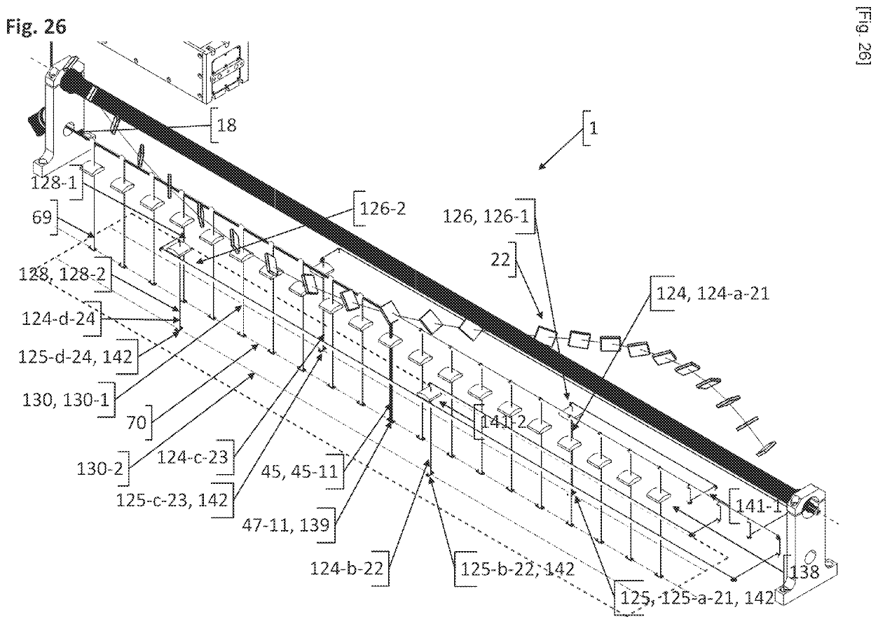

With reference to the figure [FIG. 26], we see a second complementary arrangement of the fourth variant of the preferred configuration of the Device (1) described above. Preferably, the Device (1) is equipped with a Focusing Assembly (107) consisting of Cylindrical Focusing Lenses (108), fixed with respect to the Secondary Support (116); and having an Optical Cylinder Axis (111) substantially parallel to the Impact Plane (48).

These Cylindrical Focusing Lenses (110) are each configured to focus either a Secondary Laser Beam (45) or a Deflected Secondary Laser Beam (124) according to a Rectangular Laser Impact Spot (112) on the Impact Plane (48), oriented according to a Rectangular Spot Axis (115). These Cylindrical Focusing Lenses (110) are geometrically configured in such a way that the Focusing Assembly (107) is divided into two groups. A first group forms the Longitudinal Focusing Collection (137), made up of Longitudinal Cylindrical Focusing Lenses (138). That is to say that their Optical Cylinder Axis (111) is substantially longitudinal with respect to the Rotation Axis (15). They are focused on a Longitudinal Rectangular Laser Impact Spot (139). A second group forms the Transverse Focusing Collection (140), made up of Transverse Cylindrical Focusing Lenses (141). That is to say that their Optical Cylinder Axis (111) is substantially transverse to the Rotation Axis (15). They are focused on a Transverse Rectangular Laser Impact Spot (142).

The Device (1) comprises both a Planar Array Of Secondary Beams (69) and two Deflected Planar Arrays Of Secondary Beams (128, 128-1, 128-2). The Planar Array Of Secondary Beams (69) is made up of Secondary Laser Beams (45, 45-11) emitted by the Rotating Optical Assembly (22), which impact the Impact Points (47) on the main Impacts Dotted Line (70). The two Deflected Planar Arrays Of Secondary Beams (128, 128-1, 128-2) are each made up of Deflected Secondary Laser Beams (124, 124-a-21, 124-b-22, 124-c-23, 124-d-24) issued from a different Auxiliary Reflector Assembly (126, 126-1, 126-2), which impact the Deviated Impact Points (125, 125-a-21, 125-b-22, 125-c-23, 125-d-24) of two auxiliary Deviated Impacts Dotted Line (130, 130-1, 130-2).

We see that according to the invention the Longitudinal Cylindrical Focusing Lenses (138), and the Transverse Cylindrical Focusing Lenses (141) are positioned in a complementary and exclusive manner in two groups. A first group (110-1) focuses the Planar Array Of Secondary Beams (69) on its Impacts Dotted Line (70), only according to Longitudinal Rectangular Laser Impact Spots (139), or only according to Transverse Rectangular Laser Impact Spots (142). In the case described in the figures, the first group (110-1) consisting of Longitudinal Cylindrical Focusing Lenses (138) focuses the Planar Array Of Secondary Beams (69) on its Impacts Dotted Line (70) only according to Longitudinal Rectangular Laser Impact Spots (47-11, 139). Alternatively, and exclusively from the previous one, the second group (110-2) focuses the two Deflected Planar Arrays Of Secondary Beams (128, 128-1, 128-2) on the two Deviated Impacts Dotted Lines (130, 130-1, 130-2), only according to Transverse Rectangular Laser Impact Spots (142), or only according to Longitudinal Rectangular Laser Impact Spots (139). In the case described in the figures, the second group (110-2) of Transverse-Cylindrical Focusing Lenses (141, 141-1, 141-2) focuses the Deflected Planar Arrays Of Secondary Beams (128) on two Deviated Impacts Dotted Lines (130, 130-1, 130-2) only according to Transverse Rectangular Laser Impact Spots (142, 125-a-21, 125-b-22, 125-c-23, 125-d-24).

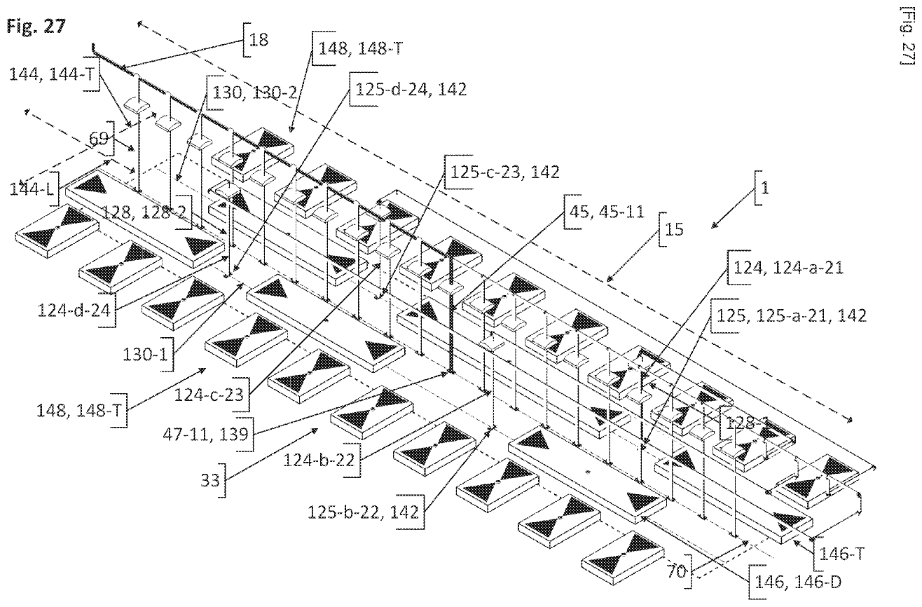

With reference to the figure [FIG. 27], we see a fifth variant of preferred configuration of the Device (1) of the invention. We see that the Device (1) comprises Sensor Assembly (33) composed of Directional EMATs (143), of the type presenting a Privileged Directional Sensing Orientation (144, 144-L, 144-T) of the ultrasonic Induced Signals (11) generated by the interaction of Mechanical Vibrations (8) with Surface-Discontinuities (12) and/or Sub-Surface Discontinuities (13).

The Sensor Assembly (33) is configured to be divided into two groups. A first group forms the Collection Of Longitudinal Sensors (145), made up of Longitudinal EMATs (146, 146-T, 146-D), that is to say with a Privileged Directional Sensing Orientation (144, 144-L) oriented in a longitudinal direction with respect to the Rotation Axis (15). And a second group forms the Collection Of Transverse Sensors (147), made up of Transverse EMATs (148, 148-T, 148-D), that is to say with a Privileged Directional Sensing Orientation (144, 144-T) in a transverse direction with respect to the Rotation Axis (15).

We see that the Transverse Rectangular Laser Impact Spots (142, 15-a-21, 125-b-22, 125-c23, 125-d-24) are (in number) mainly (and in the figure all) located between two Longitudinal EMATs (146). And the Longitudinal Rectangular Laser Impact Spots (139, 47-11) are (in number) mainly (and in the figure all) located facing and above or below the Transverse EMATs (148), perpendicularly to the Rotation Axis (15).

We see in the figure [FIG. 27] that the Rotating Optical Assembly (22) is geometrically configured in such a way that the Planar Array Of Secondary Beams (69) is made up of Secondary Laser Beams (45, 45-11) which impact the Impact Points (139, 47-11) of the main Impacts Dotted Line (70).

In addition, the two Deflected Planar Array Of Secondary Beams (128, 128-1, 128-2), are made up of two groups of Deflected-Secondary Laser Beams (124-a, 124-c) and (124-b, 124-d), resulting from two Auxiliary Reflector Assemblies (126, 126-1, 126-2), which impact two auxiliary remote Deviated Impacts Dotted Line (130, 130-1, 130-2). We see that the main Impacts Dotted Line (70) and the two auxiliary Deviated Impacts Dotted Line (130, 130-1, 130-2) are all three parallel to the Rotation Axis (15) and distant from each other. According to this preferred configuration of the invention, the two auxiliary Deviated Impacts Dotted Line (130, 130-1, 130-2) are located on either side, which is to say above and below the main Impact Line (70).

We see in the figure [FIG. 27] that the Rotating Optical Assembly (22) is geometrically configured in such a way that the main Impacts Dotted Line (70) is formed only of Longitudinal Rectangular Laser Impact Spots (139). And its two auxiliary Deviated Impacts Dotted Line (130, 130-1, 130-2) are formed solely of Transverse Rectangular Laser Impact Spots (142, 125-a-21, 125-b-22, 125-c-23, 125-d24).

We see in the figure [FIG. 27] that the Device (1) and its Rotating Optical Assembly (22) are geometrically configured in such a way that its Longitudinal EMATs (146, 146-T, 146-D) are mainly (in number) (and in the figure all) aligned on either side and in an alternating manner vis-à-vis the main Impacts Dotted Line (70). In addition, they are positioned longitudinally next to a Transverse Rectangular Laser Impact Spot (142, 125a-21, 125-b-22, 125-c-23, 125-d-24) of one of the two auxiliary Deviated Impacts Dotted Lines (130, 130-1, 130-2). And moreover, its Transverse EMATs (148, 148-T, 148-D) are mainly (in number) (and in the figure all) positioned and aligned alternately above and/or below the Longitudinal EMATs sensors (146, 146-T, 146-D), in a direction perpendicular to the Rotation Axis (15).

In an advantageous configuration recommended by the invention, the Device (1) is further equipped with Means Of Angular Position Monitoring (149) of the single Rotating Shaft (14), and therefore of the Monolithic Rotating Optical Assembly (22) rotating with respect to the Rotation Axis (15); and connected to the single Rotating Shaft (14). It also includes Means Of Laser Pulses Monitoring And Timing (150), electrically connected to the Incoming Laser Source (16) and configured to monitor and/or clock the generation of laser pulses by the Incoming Laser Source (16). It also includes Means of Motor Rotation Timing (151), electrically connected to the Drive Motor (24-a).

A Synchronized Laser Pulses And Rotation Timing Processor (152) is electrically connected to the Means Of Angular Position Monitoring (149) of the Rotating Shaft (14). It is also electrically connected to the Means of Motor Rotation Timing (151). It continuously receives the angular position of the Rotating Shaft (14). The Synchronized Laser Pulses And Rotation Timing Processor (152) is configured either in Motor Monitoring Mode (153) or in Pulses Monitoring Mode.

In Motor Monitoring Mode (153), the Synchronized Laser Pulses And Rotation Timing Processor (152) is configured to electrically control the Means of Motor Rotation Timing (151), depending on the timing of the laser pulses generated by the Incoming Laser Source (16). In this mode, it adaptively positions the axial angular position of the Rotating Optical Assembly (22), so that the Pulses Number Of Mirror Impacts (NIM) of the pulses of the Incoming Laser Beam (18) impacting each of the Mirrors (M, M1, . . . , M20) in rotation, in the vicinity of its Reflection Point (29) of the rotating Helical Dotted Line (43), is constant (for example NIM=2).

Alternatively, in Pulses Monitoring Mode (154), the Synchronized Laser Pulses And Rotation Timing Processor (152) is configured to electrically drive the Means Of Laser Pulses Monitoring And Timing (150), as a function of the timing information of the axial angular position of the Rotating Optical Assembly (22), continuously received from the Means Of Angular Position Monitoring (149). In this mode, it successively controls the timing of the pulses of the Incoming Laser Beam (18), so that the Pulses Number Of Mirror Impacts (NIM) of the pulses of the Incoming Laser Beam (18) impacting each of the Mirrors (M, M1, . . . . M20) in rotation, in the vicinity of its Reflection Point (29) of the rotating Helical Dotted Line (43), is constant (for example NIM=2),

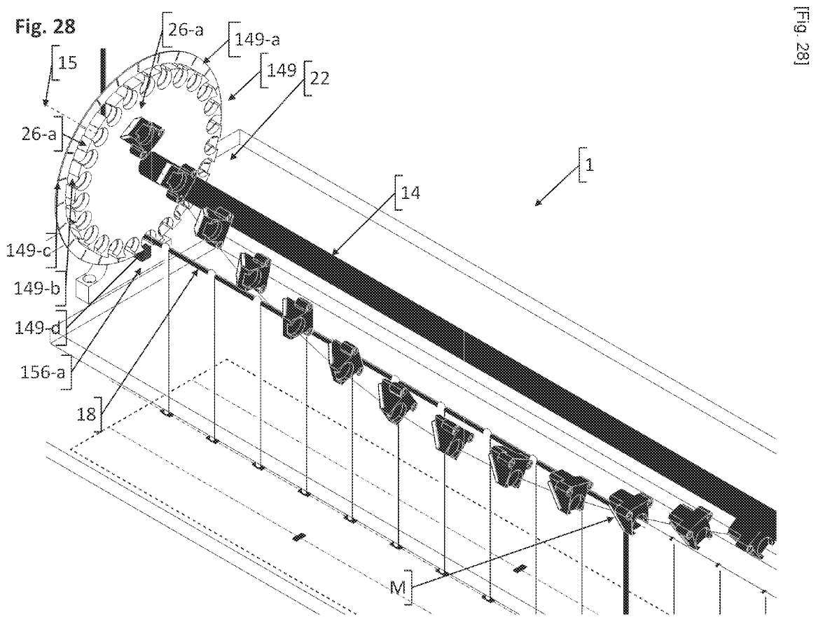

With reference to the figure [FIG. 28], we see that the Rotating Optical Assembly (22) of the Device (1) is equipped with Means Of Angular Position Monitoring (149), adapted to the implementation of the process of continuous adaptation of the rotation of the Rotating Optical Assembly (22) to the timing of the laser pulses emitted by the Incoming Laser Source (16). For ease of understanding, the rotating Support Discs (85) are not shown. We see that Means Of Angular Position Monitoring (149) include an Angular Indexing Disc (149-a). It has a diameter substantially equal to but greater than that of the lateral Flanks (26-a, 26-b) linked to the Rotating Optical Assembly (22). It is placed rigidly to the left of the left lateral Flank (26-a). So that it is fixed in relation to the Rotating Shaft (14) and rotates in concert with the Rotating Optical Assembly (22) around the Rotation Axis (15). It is pierced with 24 Circular Recesses (149-b), positioned in a ring around its perimeter, and all angularly spaced 15° around its axis. Each Circular Recess (149-b) has a diameter equal to that of the recesses made around the perimeter of the side Flanks (26-a, 26-b). It is positioned in the direction of the Rotation Axis (15) facing these recesses; so as to provide a solution of tubular continuity inside the Rotating Optical Assembly (22), through which the Incoming Laser Beam (18) can successively penetrate; to reach a rotating Mirror (M) which is successively located opposite the Circular Recess (149-b) which corresponds to it, during the rotation of the Rotating Optical Assembly (22). The Angular Indexing Disc (149-a) also has 24 Radial Slits (149-c). They are positioned in a ring around its periphery, each between a Circular Recess (149-b) and the periphery of the Angular Indexing Disc (149-a). The 24 Radial Slits (149-c) are thus all angularly spaced 15° apart, around the Rotation Axis (15).

An Optical Sensor (149-d) is placed perpendicular to the Angular Indexing Disc (149-a). It is fixed on the left Rotation Support (156-a) of the Rotating Shaft (14). Therefore, it is fixed with respect to the Device (1). It forms a clamp open on either side of the Angular Indexing Disc (149-a), through which pass successively the Radial Slits (149-c), each associated with a particular rotating Mirror (M). Each time a Radial Slit (149-c) passes through the Optical Sensor (149-d), that is to say every 15°, a signal is sent to the Means Of Angular Position Monitoring (149), identifying the angular position of a Radial Slit (149-c) and therefore the presence of a new Mirror (M) facing the Incoming Beam Axis (20). The Synchronized Laser Pulses And Rotation Timing Processor (152) then automatically performs the temporal control necessary for the generation by the Incoming Laser Source (16) of the Pulses Number Of Mirror Impacts (NIM) of required laser pulses by the Incoming Laser Beam (18) impacting the rotating Mirror (M) facing this Radial Slit (149-c).

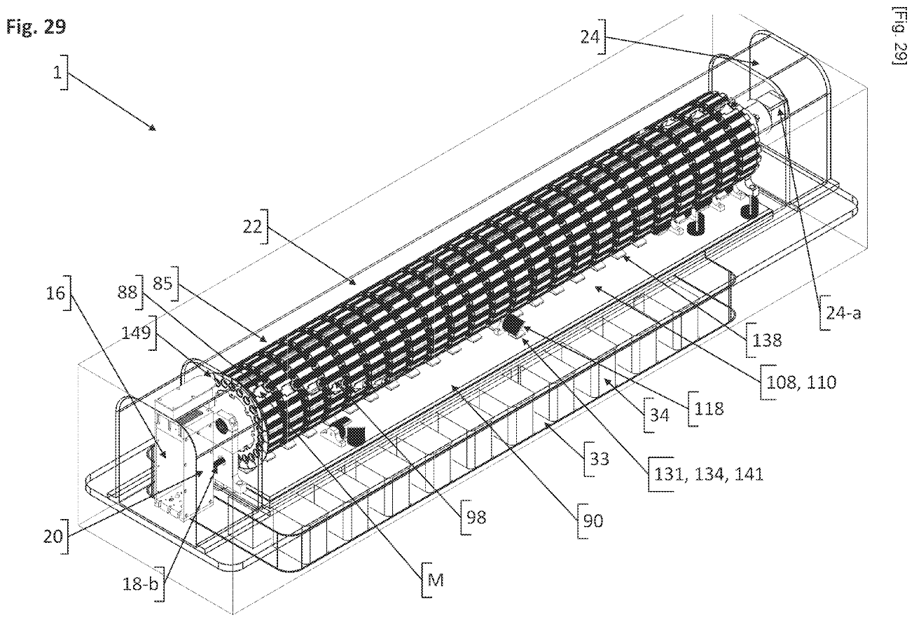

With reference to the figure [FIG. 29], we see a Device (1) according to the invention developed by the applicant, equipped with a pulsed Incoming-Laser Source (16), which has the following general characteristics: (a) Type: DPSS (semi-conductors laser pumped by diode).

The operating characteristics of the used single pulsed Incoming Laser Source (16) are as follows:
a. Energy: 100 mJ;
b. Frequency: 100 Hz;
c. Pulse power: 5 MW;
d. Pulse duration: 5-100 ns;
e. Wavelength: 1064 nm;
f. Beam diameter: 5-10 mm;
g. Size of the Longitudinal Rectangular Laser Impact Spots (139), and of the Transverse Rectangular Laser Impact Spots (142), when activated by an ABLAT Device (1) of the invention: 0.1-3 mm x 5-20 mm.

The Device (1) periodically generates:
a. twenty Secondary Laser Beams (45), impacting twenty Impact Points (47) of a main Impacts Dotted Line (70); and,
b. four deflected Auxiliary Laser Beams (119), impacting four Deviated Impact Points (125) distributed in groups of two, along two distant Deviated Impacts Dotted Lines (130).

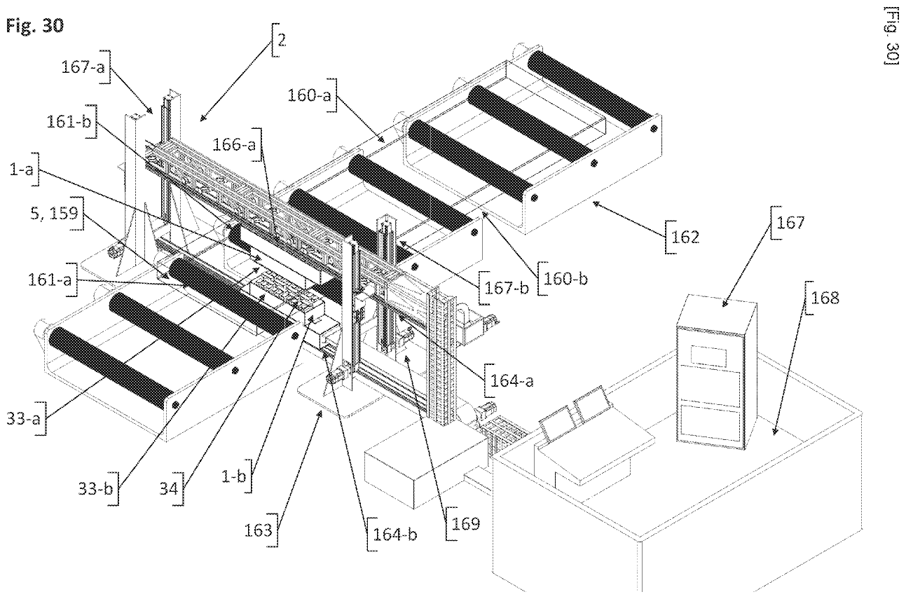

With reference to the figure [FIG. 30], we see a Machine Tool (2) (3-D scanner), developed by the applicant, equipped with two UNDT optical electromagnetic acoustic hybrid EMATs/Laser Devices (1, 1-a, 1-b), of the type described in the figure [FIG. 29], each powered by a single Incoming Laser-Source (16) mentioned above. The Machine Tool (2) performs 3-D scanning of Steel Slabs (5, 159), during or after their continuous casting in a steel mill, at a temperature of up to 1200° C.

The first Device (1a) inspects the Upper Face Of Slab (160-a) and is located above it; so that its Sensor Assembly (33-a) including 26 EMATs (34) is located opposite this upper face.

The second Device (1b) inspects the Bottom Face Of Slab (160-b) and is located below it; so that its Sensor Assembly (33-b) including 26 EMATs (34) is located opposite this bottom face.

The two Devices (1a, 1b) are positioned face to face, on either side of the Steel Slab (5, 159), in a vertical plane located between two Conveyor Rollers (161-a; 161-b) of the Conveyor (162) of the continuous steel casting line, on which the Steel Slab (5, 159) is moved longitudinally.

The Machine Tool (2) is equipped with a robotic Mechanical Assembly (163), activated by a Digital Control Processor (167), located in the Piloting Operator Zone (168). It comprises an Upper Guiding Rail (164-a), equipped with an Upper Support (166-a) with a motorised transverse movement according to this guiding rail; and with a Lower Guiding Rail (164-b) equipped with a Lower Support (166-b) with a motorised transverse movement according to this motorised guiding rail. The two Guiding Rails (164-a, 164-b) are positioned horizontally, perpendicularly and on either side of the upper and bottom faces of the Steel-Slab (5, 159).

The upper Device (1-a) is fixed on the motorised Upper Support (166-a) below the Upper Guiding Rail (164-a). It is thus moved transversely to adapt its position to the position of the Steel-Slab (159) on the Conveyor (162), or to be placed in the lateral Maintenance Zone (169).

The lower Device (1-b) is fixed on the motorised Lower Support (166-b) above the Lower Guiding Rail (164-b). It is thus moved transversely to adapt its position to the position of the Steel Slab (159) on the Conveyor (162), or to be placed in the lateral Maintenance Zone (169).

The Mechanical Assembly (163) also includes two groups of Side Motorised Rails (167-a, 167-b) each forming a vertical support post. They are located on either side of the Conveyor (162). They include motorised means making it possible to adjust the vertical position of the Upper Guiding Rail (164-a) and therefore of the upper Device (1-a), depending on the potentially variable thickness of the inspected Steel Slabs (159).

Each of the two Devices (1-a, 1-b) of the Machine Tool (2) is equipped with 26 EMAT type Electromagnetic Acoustic Transducers (34) of the type described in French patent application No. FR2009138, in the name of the applicant.

The Machine Tool (2) is dimensioned and configured so that the scanning speed, which is to say the longitudinal speed of movement of the Steel Slabs (159) with respect to the two Devices (1, 1-a, 1-b), is 0.150 m per second.

The size specifications of the inspected Steel Slabs (5, 159) are in the following range: (a) thickness 100-350 mm, (b) width 1000-2000 mm.

The Machine Tool (2) can automatically and continuously detect, whatever their orientation, any Surface Discontinuities (12) and Sub-Surfaces Discontinuities (13) in the Body (9) of a Steel Slab (5, 159): (a) with a signal which is 6 dB greater than the signals coming from the internal structure of the material of the steel slab, (b) with a width greater than 0.1 mm, (c) with a height greater than 0.3 mm, and, (d) with a length greater than 10 mm.

### Advantageous Effects of Invention

It appears from the description given above that the Device (1) of the invention, of UNDT hybrid EMATs/Laser transducers type, has the following advantages:
a. It comprises a single monolithic Rotating Optical Assembly (22) of mechanical and/or optical parts, in rotary movement around a single Rotation Axis (15).
b. All of its rotating mechanical and/or optical parts are rigidly linked together.
c. It is equipped with a single Drive Motor (24-a) and one Rotating Shaft (14).
d. Its number of moving parts is minimal. And therefore, its cost is minimized. Its reliability is increased. Its Mean Time Between Failures (MTEP) (designated by MTBF in English) is extended. And its maintenance need is minimal.
e. Its vertical dimension is reduced by at least 50% compared to prior art devices. And therefore, its industrial applications in confined environments are more numerous.
f. Its Rotating Optical Assembly (22) is equipped with rotating Mirrors (M) which are all mechanically linked together and arranged along a rotating Helical Dotted Line (43) with circular cylindrical screw thread. When the Drive Motor (24-a) is activated; the rotating Mirrors (M) and the rotating Helical Dotted Line (43) which connects them, do not perform any longitudinal reciprocating movement according to the Rotation Axis (15). This reduces vibration generation and provides immunity to external environmental vibrations.
g. Thus, the Rotating Optical Assembly (22) can rotate reliably at more than 3000 rpm; and therefore, generate up to 1200 distant laser impacts per second.
h. It also has one of Tubular Rigidification Assemblies (90-a, 90-b) which concomitantly provide longitudinal stiffening and immunization to transverse and longitudinal vibrations of the Rotating Optical Assembly (22); as well as safety protection by encapsulation of the Incoming Laser Beam (18), during the rotation of the Rotating Optical Assembly (22). This fundamental characteristic is not achieved by the prior art.
i. The monolithic Rotating Optical Assembly (22) of the invention as described above allows, (i) from the same Incoming Laser Beam (18), (ii) to carry out periodic guidance of series of agile multifocal laser beams made of 24 or more distant and parallel outgoing laser beams.
j. The monolithic Rotating Optical Assembly (22) of the invention makes it possible, to emit periodically and at high frequency these 24 outgoing secondary laser beams, organized in 3 parallel planes, whereas, (i) a group of 20 Secondary Laser Beams (45) impacts a main Impacts Dotted Line (70) made of 20 laser impacts; and, (ii) a group of 4 Deflected Secondary Laser Beams (124, 124-a-21, 124-b-22, 124-c-23, 124-d-24) impacts two auxiliary Deviated Impacts Dotted Line (130-1, 130-2) each made of 2 laser impacts, parallel and distant from the main Impacts Dotted Line (70).
k. It provides quasi-conservation of energy between the Incoming Laser Power (PI) and the Outgoing Laser Power (PO) of each secondary laser beam.
l. It allows, from a single Incoming Laser Beam (18) having a certain Incoming Laser Power (PI), to periodically fire outgoing laser beams of the same power on 24 impact points, with a firing frequency of up to 1200 hertz. This type of laser impact frequency cannot be achieved by the prior art, for mechanical reasons.
m. For a given Incoming Laser Power (PI) and a given volume of the Device (1), it significantly increases the number, energy, and frequency of Laser Shocks (7) on the Control Zone (3), as well as the number, amplitude, and signal-to-noise ratio of A-Scan Signals (AS) detected by the EMAT type Electromagnetic Acoustic Transducers (34).
n. And therefore, it economically and reliably increases the quality control resolution of the Metal Workpiece (5).

The ABLAT type Rotating Optical Assembly (22) described and constructed by the applicant makes it possible to periodically carry out 24 laser shots at 1200 hertz at 24 impact points distributed over a Control Zone (3) 1200 mm long, while having a vertical footprint of less than 300 mm. No prior art UNDT hybrid EMATs/Laser optical-electromagnetic-acoustic type device can achieve this performance with this minimal space requirement.

Thanks to the combination (a) on the one hand of Longitudinal Cylindrical Focusing Lenses (138) focusing Longitudinal Rectangular Laser Impact Spots (139) and of Transverse Cylindrical Focusing Lenses (141) focusing Transverse Rectangular Laser Impact Spots (142); and, (b) on the other hand, Longitudinal EMATs (146) with Privileged Directional Sensing Orientation (144) in a longitudinal direction, and Transverse EMATs (148) with Privileged Directional Sensing Orientation (144) in a transverse direction; the Device (1) detects and qualifies the Surface Discontinuities (12) and the Sub-Surface Discontinuities (13) in the Body (9) of the Metal Workpiece (5), having any orientations, also well with a mainly longitudinal slenderness than a mainly transverse slenderness. This fundamental characteristic is not achieved by the prior art.

The cost of manufacturing a device of UNDT hybrid EMATs/Laser transducers type according to the prior art for the continuous control of a 1200 mm wide steel slab face is currently estimated by the scientific community at €1 million. The technology of the invention makes it possible, with a single Incoming Laser Source (16), to reduce this cost by a factor of five, with equivalent performance, productivity, and control resolution.

### INDUSTRIAL APPLICABILITY

The invention offers valuable industrial advantages and applications in the metallurgical industry, and in all fields of engineering and mechanical construction.

The invention offers industrial applications for automated non-destructive testing and 2D and/or 3D ultrasonic scanning of large metallurgical objects, in particular for continuous 3D scanning and the characterization of surfaces and/or sub-surfaces discontinuities of these large metal objects. The invention thus improves the quality control of metal construction parts.

The preferred industrial applications of the invention relate to B-Scanning and/or C-Scanning and/or high-throughput continuous 3D NDT imaging of surface and internal discontinuities, in the production of large and thick metallurgical structures and/or industrial components made of a conductive material such as steel or aluminium.

A first main industrial application of the invention is that of continuous 3D NDT control of steel slabs during their continuous casting, in the harsh industrial environment and at elevated temperature (above 1000° C.) of a steel mill.

A second main industrial application of the invention is the 3D NDT generation of topological parameters of steel slab discontinuities during their continuous casting, with a view to their use for the optimal manual or automatic adjustment of the equipment parameters for dynamic reduction (called «Dynamic Soft Reduction» or DSR in English) of the continuous casting line of a steel mill.

1. An ultrasonic non-destructive test Device (1) of hybrid electromagnetic acoustic/Laser transducers type comprising a monolithic Rotating Optical Assembly (22) of agile laser array transmitters providing multifocal laser beams guidance by jumps for the control of metallurgical objects, to equip a Machine Tool (2) carrying out quality control of metal processing, on a Control Area (3) of the Surface (4) of a Metal Workpiece (5), of the type inducing Mechanical Vibrations (8) in the Body (9) the Metal Workpiece (5), and, monitoring generated ultrasonic Induced Signals (11) to identify Surface Discontinuities (12) and Sub-Surface Discontinuities (13); this Device (1) comprising: (a) a Rotating Shaft (14), capable of rotating about a Rotation Axis (15); (b) an Incoming Laser Source (16), equipped with Optical Guidance Means (17), configured to produce an Incoming Laser Beam (18), with a certain Incoming Laser Power (PI), directed along an Incoming Beam Axis (20) parallel to the Rotation Axis (15), this at a certain Beam Distance (21) from the Rotation Axis (15); (c) a Rotating Optical Assembly (22) configured to rotate about the Rotation Axis (15); and incorporating a Reflector Assembly (25), (i) composed of a plurality of n (at least two) Mirrors (M, M1, M2 . . . , M11, M21 . . . , M24), acting as an Optical Barrier (27), (ii) each of which Mirrors (M, M11) being configured so that, in certain rotary positions of the Rotating Optical Assembly (22), the Mirror (M) intercepts the Incoming Beam Axis (20), (iii) each of which Mirror (M) having a Reflection Point (29, 29-11), i) being positioned at a rotating Reflection Distance (32) perpendicular to the Rotation Axis (15), ii) for reflecting the Incoming Laser Beam (18) impacted on this Mirror (M), iii) with a change in Beam Angular Direction (A), and, iv) with a Reflection Efficiency (E) of the energy of the Incoming Laser Beam (18) substantially equal to one hundred percent; (iv) geometrically configured such that, i) the Incoming Laser Beam (18) successively impacts a Reflection Point (29, 29-11) associated with and belonging to one of its n distant Mirrors (M, M11), ii) each of n Reflection Points (29, 29-11) of the n Mirrors (M), travels through a Circle of Rotation (C, C-1 . . . , C-11 . . . ), of a Radius of Rotation (37, 37-1 . . . 37-11 . . . ), centered on a Center of Rotation (CR, CR-1 . . . , CR-11 . . . ) fixed on the Rotation Axis (15), and iii) the n different Mirrors (M, M1, M2 . . . , M11, M21 . . . . M24) redirect in an agile manner, successively and discontinuously the Incoming Laser Beam (18) according to a Secondary Beam Collection (44), made of a bundle of n distant Secondary Laser Beams (45, 45-1 . . . , 45-11 . . . , 45-24), resulting from a multitude of successive and discontinuous changes in the Beam Angular Direction (A) of the Incoming Laser Beam (18), by reflection on the succession of n Mirrors (M) distant and in rotation; and, (v) geometrically configured such that the n Secondary Laser Beams (45) generated successively impact an Impact Set (46) made up of a multitude of n distant Impact Points (47, 47-1, 47-11 . . . , 47-21 . . . , 47-24), located i) either on the Impact Plane (48), facing the Rotating Optical Assembly (22), located on the Surface (4) of the Control Area (3), and near a Detection Point (36) of an EMAT type Electromagnetic Acoustic Transducer (34), or, ii) either on an Auxiliary Mirror (49, 49-21 . . . , 49-24); (d) Rotation Means (24) of the Rotating Optical Assembly (22), (i) comprising a Drive Motor (24-a), connected to the Rotating Shaft (14), and, (ii) configured to induce a rotation of the Rotating Shaft (14) around the Rotation Axis (15), with a continuous Direction of Rotation (DR); (e) a Sensor Assembly (33), composed of a plurality of p (at least two) EMAT type Electromagnetic Acoustic Transducer (34), hereinafter referred to as EMATs, each of which Active Electromagnetic Probe (35); (i) faces the Control Area (3) and is substantially centered on a Detection Point (36) of the Control Area (3), and, (ii) is configured to generate an A-Scan Signal (AS) for detecting the position of the Defaults (12, 13) versus time/distance, acquired from the Induced Signals (11) in the vicinity of its Detection Point (36): this Device (1) being characterized in that it presents the following combination of technical features:
a. its Rotating Optical Assembly (22), including its n Mirrors (M), their mechanical connection parts and its n associated Reflection Points (29, 29-11), in rotation, (i) is monolithic, that is to say it is made up of mechanical and/or optical parts all rigidly mechanically linked together and in fixed, non-modifiable position relative to each other, and, (ii) is rigidly fixed by Fixing Means (23) on the same Rotating Shaft (14), and, (iii) has a rigid geometry that is non-deformable during its rotation:
b. the n Mirrors (M) of the Reflector Assembly (25) and their n associated Reflection Points (29, 29-11) are in fixed position relative to the same Rotation Axis (15);
c. the rotating Reflection Distances (32) of the n Reflection Points (29, 29-11) of all the Mirrors (M), perpendicularly and with respect to the Rotation Axis (15), are all (i) constant and equal to each other during said rotation, and (ii) substantially equal to the Beam Distance (21);
d. each of the n Reflection Points (29, 29-11) of the n Mirrors (M), travels through a Circle of Rotation (C, C-1, . . . , C-11, . . . ), (i) centered on the Rotation Axis (15), and (ii) maintained perpendicular to the Rotation Axis (15) during said rotation;
e. each of the n Circles of Rotation (C) (i) presents a projection, parallel to a projection plane parallel to the Rotation Axis (15) and passing through its Center Of Rotation (CR, CR-1, . . . , CR-11, . . . ), formed of a Segment of Transverse Cross-Motion (ST, ST-1, . . . , ST-11, . . . ), perpendicular to the Rotation Axis (15) and centered on its Center of Rotation (CR), and, (ii) presents a projection, parallel to a plane of rotation perpendicular to the Rotation Axis (15) and passing through its Center of Rotation (CR, CR-1, . . . , CR-11, . . . ), formed of a Circle Of Planar Projected Motion (CP, CP-1, . . . , CP-11, . . . ), coincident with the Circle of Rotation (C), and having a Radius Of Projected Rotation (RP, RP-1, . . . , RP-11, . . . ), equal to the Beam Distance (21) during said rotation;
f. each Reflection Point (29) of a Mirror (M) is positioned in a fixed manner with respect to the same rotating Cylindrical Reflection Surface (38) of a Virtual Reflection Cylinder (39) of revolution and rotating, (i) having a constant circular section, (ii) in rotation around the Rotation Axis (15), (iii) whose Reflection Cylinder Radius (41) is constant and substantially equal i) to the Radii of Rotation (37, 37-1, . . . , 37-11, . . . ) of each of the n Circles of Rotation (C, C-1, . . . , C-11, . . . ), and, ii) to the Beam Distance (21), (iv) so that the cross section of the Virtual Cylinder Reflection (39) of revolution and its rotating Cylindrical Reflection Surface (38) is constantly circular, (v) but whose longitudinal position is fixed with respect to the Rotating Shaft (14), that is to say without any longitudinal movement with respect to the Rotation Axis (15);
g. the Reflection Points (29) of the Mirrors (M) are positioned on a rotating Helical Dotted Line (43), (i) with circular helical winding, of radius equal to the Beam Distance (21), (ii) and with circular cylindrical screw thread, (iii) fixed together with its points on the Cylindrical Reflection Surface (38), and in rotation with it, but, (iv) whose longitudinal position is fixed with respect to the Rotating Shaft (14), that is to say without any longitudinal displacement with respect to the Rotation Axis (15);
h. the Incoming Laser Beam (18) is, during its rotation, positioned along successive rectilinear Reflection Generating Lines (42) of the rotating Cylindrical Reflection Surface (38), (i) each attached to a Reflection Point (29) of a Mirror (M), (ii) moving in rotation with the Virtual Reflection Cylinder (39), (iii) but without longitudinal movement with respect to the Rotation Axis (15).

2. The Device (1) according to claim 1, characterized in that, in a Cylindrical Coordinate System (CCS), whose Polar Cylindrical Axis (52) coincides with the Rotation Axis (15), and whose Reference Plane (53) is perpendicular to the Rotation Axis (15) and intersects it at a certain Point Of Origin (O),
a. the Angular Polar Distances (DO) between the Angular Coordinates (θ) of two successive Reflection Points (29) of the Helical Dotted Line (43) joining all the Reflection Points (29) and circularly wound, are positive and constant;
b. the Cylindrical Distances (r) of the Reflection Points (29) are constant and all equal to the Beam Distance (21); and,
c. the circular cylindrical Pitch Of Screw (57) of the Helical Dotted Line (43) is positive and constant.

3. The Device (1) according to claim 2, characterized in that: the constant Angular Polar Distances (Dθ) are approximately equal to 360° divided by the Number of Mirrors (n), Dθ=360°/n; so that in the Cylindrical Coordinate System (CCS),
a. the Overall Reflection Length (Z), consisting of the difference between the Heights (z1, zn) of the two Extremal Mirrors (M1, Mn) of the Rotating Optical Assembly (22) which are furthest apart, is substantially equal to the cylindrical Pitch Of Screw (57) of the Helical Dotted Line (43); and,
b. the Reflector Assembly (25) presents an Angular Spectrum of Angular Coordinates (θ) covering substantially 360°.

4. The Device (1) according to claim 1, characterized in that, when we consider for each Mirror (M, M11) its Radial Segment (63), joining its Reflection Point (29) to its Projection Point (64) on the Rotation Axis (15); for each Mirror (M) and with respect to its Orientation Plane (65) passing through the Reflection Point (29, 29-11) and perpendicular to the Radial Segment (63): (a) the Radial Segment (63) has a constant Radial Length (62) equal to the Beam Distance (21); (b) the rotating Roll Angle (AR) relative to the Rotation Axis (15) is zero at 0°; (c) the rotating Pitch Angle (AP) relative to the Rotation Axis (15) is the same for all Mirrors (M); and, (d) the longitudinal position of the Projection Point (64) of each Radial Segment (63) is fixed along the Rotation Axis (15) and with respect to the Rotating Shaft (14); so that:
a. the Secondary Laser Beams (45), (i) are all parallel and arranged according to the same Secondary Beams Plane (68), passing through the Rotation Axis (15) and perpendicular to the Impact Plane (48); and (ii) are arranged according to a Planar Array Of Secondary Beams (69); and,
b. all the Impact Points (47) of the Control Area (3) are aligned on a rectilinear Impacts Dotted Line (70) of the Impact Plane (48) and are positioned apart at certain Impacts Distance (71) between two adjacent Impact Points (47).

5. The Device (1) according to claim 4, characterized in that: (a) the rotating Pitch Angle (AP), relative to the Rotation Axis (15), of each Mirror (M) is fixed equal to 45°, and, (b) the Control Area (3) and the Impact Plane (48) are parallel to the Rotation Axis (15); so that:
a. the Secondary Laser Beams (45) are each perpendicular to the Impact Plane (48); and,
b. the Secondary Length (72) of each of the Secondary Laser Beams (45), and therefore the Vertical Dimension (73) of the Rotating Optical Assembly (22) are minimized.

6. The Device (1) according to claim 1, characterized in that it is equipped with at least one digital B-Scan Processor (BSP), connected to the EMAT type Electromagnetic Acoustic Transducers (34), configured for;
a. processing and combining the information from their detection A-Scan Signals (AS), and,
b. generating a two-dimensional digital B-Scan Presentation (75) of a section of the Metal Workpiece (5), (i) in a B-Scan Plane (SAP) substantially coincident with the vertical Secondary Beams Plane (68), perpendicular to the Impact Plane (48) of the Control Area (3) of the Metal Workpiece (5), (ii) substantially along the Detection Line (77) joining the Impacts Dotted Line (70), and, (iii) representing the Digital Positions (78) with respect to their Depth (79) of the Discontinuities (12, 13) in the B-Scanning Plane (SAP).

7. The Device (1) according to claim 1, characterized in that:
a. its Rotating Optical Assembly (22) is made up of a mechanical assembly of substantially geometrically identical Support Sections (80), and which are arranged side by side along the Rotation Axis (15);
b. the Support Sections (80) are rigidly assembled together,
c. a Mirror (M) is fixed on each Support Section (80); and,
d. in the Cylindrical Coordinate System (CCS), whose Polar Cylindrical Axis (52) coincides with the Rotation Axis (15), two adjacent Support Sections (80) equipped with their Mirror (M), are rotated, relative to each other, perpendicularly to the Rotation Axis (15), of the same Angular Polar Distance (Dθ) between two successive Reflection Points (29) belonging to their respective Mirrors (M) of the Helical Dotted Line (43).

8. The Device (1) according to claim 7, characterized in that:
a. its Support Sections (80) each have the shape of an elongated Support Beam (81), the Support Axis (82) of which intersects the Rotation Axis (15);
b. each Support Beam (81) is fixed to the Rotating Shaft (14) by a Fixing Means (83);
c. a Mirror (M) is fixed on a Support End (84) of each Support Beam (81).

9. The Device (1) according to claim 7, characterized in that:
a. its Support Sections (80) each have substantially the shape of a Support Disc (85) of flat cylindrical shape;
b. each Support Disc (85) is pierced with a Fixing Hole (86), provided perpendicularly and in its center, and whose Hole Diameter (87) is substantially equal to the diameter of the Rotating Shaft (14);
c. the Support Discs (85) are embedded side by side on the Rotating Shaft (14), along it and in a stacking plane perpendicular to the Rotation Axis (15), through their Fixing Hole (86); and,
d. each Support Disc (85) is provided with a Support Housing (88), provided on its Disc Periphery (89), on which its Mirror (M) is fixed.

10. The Device (1) according to claim 7, characterized in that:
a. its Rotating Optical Assembly (22) is equipped with a Rigidification Assembly (90), consisting of a plurality of Rigid Rods (91), (i) the Rigidification Axis (92) of which is parallel to the Rotation Axis (15), (ii) fixed relative to the Rotating Shaft (14), and fixed relative to each other; and,
b. each Rigid Rod (91) passes through at least one Support Section (80); to which it is rigidly fixed by a Nesting (93) in a Rigidification Recess (94) of this Support Section (80).

11. The Device (1) according to claim 10, characterized in that:
a. the Rigid Rods (91) are arranged substantially along rectilinear Rigidification Generating Lines (95) of the same Virtual Rigidification Cylinder (96) of revolution, and,
b. the Rigidification Cylinder Axis (97) of the Virtual Rigidification Cylinder (96) is confused with the Rotation Axis (15).

12. The Device (1) according to claim 11, characterized in that:
a. the Support Sections (80) of its Rotating Optical Assembly (22) each have the shape of Support Disks (85), geometrically identical and of flat cylindrical shape, arranged side by side, perpendicularly and centered in relation to the Rotation Axis (15);
b. each Support Disc (85) is provided with a Support Housing (88) provided on its Disc Periphery (89), on which its Mirror (M) is fixed;
c. its Rigidification Assembly (90) is formed of Rigid Rods (91) each consisting of a rectilinear Rigid Hollowed Tube (98), (i) internally providing an empty Longitudinal Canal (99, 99-a) crossing it from side to side, according to its Rigidification Axis (92), and, (ii) the Longitudinal Canal (99) of which is arranged substantially along a rectilinear Rigidification Generating Line (95) of the Virtual Rigidification Cylinder (96);
d. the distance of each Longitudinal Canal (99) with respect to the Rotation Axis (15) is constant, and substantially equal to the Reflection Cylinder Radius (41) and to the Beam Distance (21), so that the Virtual Rigidification Cylinder (96) is substantially confused with the Virtual Reflection Cylinder (39) of revolution;
e. the Rigid Hollowed Tube (98; 98-a) are embedded in successive Disc Notches (100) provided on the disc periphery of certain Support Discs (85).

13. The Device (1) according to claim 12, characterized in that: (a) its Rigidification Assembly (90) comprises an Upstream Tubular Rigidification Assembly (90-a) constituted by Upstream Rigid Hollowed Tubes (98-a), which have different Tube Lengths (101), and are geometrically configured so that they each extend longitudinally between, (i) on the one hand, an Upstream End of Upstream Tube (102-a), i) located in the vicinity of the same Upstream Lateral Face (103-a) of the first Upstream Support Disc (104-a) of the Rotating Optical Assembly (22), ii) through which the Incoming Laser Beam (18) penetrates perpendicularly, (ii) and on the other hand, a Downstream End of Upstream Tube (105-a), arranged facing the Mirror (M) of a particular variable Intermediate Support Disc (106), different for each Upstream Rigid Hollowed Tube (98-a); such that, when the Drive Motor (24-a) and the Incoming Laser Source (16) are activated:
a. the Rigidification Axes (92) of the Upstream Rigid Hollowed Tubes (98-a) rotate along the rectilinear Reflection Generating Lines (42) of the Virtual Reflection Cylinder (39) of revolution;
b. the Incoming Laser Beam (18) (i) successively penetrates through the Longitudinal Canal (99) of one of the successive Upstream Rigid Hollowed Tubes (98-a), (ii) and impacts successively the Reflection Point (29) of a Mirror (M) of a particular Intermediate Support Disc (106) facing it;
c. so that the Upstream Tubular Rigidification Assembly (90-a) concomitantly ensures (i) stiffening and immunization to longitudinal vibrations of the Rotating Optical Assembly (22), and (ii) safety protection by encapsulation of the Incoming Laser Beam (18) during the rotation of the Rotating Optical Assembly (22).

14. The Device (1) according to claim 13 characterized in that: (a) its Rigidification Assembly (90) further comprises a Downstream Tubular Rigidification Assembly (90-b), constituted by Downstream Rigid Hollowed Tubes (98-b), which have different Tube Lengths (101), and are geometrically configured so that they each extend longitudinally between, (i) on the one hand, an Upstream End of the Downstream Tube (102-b), arranged behind the Mirror (M) of a particular Intermediate Support Disc (106), different for each Downstream Rigid Hollowed Tube (98-b); and, (ii) on the other hand, a Downstream End of the Downstream Tube (105-b), located in the vicinity of the same Downstream Lateral Face (103-b) of the last Downstream Support Disc (104-b) of the Rotating Optical Assembly (22); (b) the Upstream Tubular Rigidification Assembly (90-a) and the Downstream Tubular Rigidification Assembly (90-b) (i) have a similar topology, and, are complementary, and (ii) are substantially the image of each other, after a mirror reflection combined with an axial rotation of 180°; in such a way that:
a. the combination of the Upstream Tubular Rigidification Assembly (90-a) and the Downstream Tubular Rigidification Assembly (90-b) (i) ensures stiffening and immunization to longitudinal vibrations of the Rotating Optical Assembly (22) over its entire length during its rotation, and (ii) serves as a guide to allow easy assembly and angular indexing of the Support Discs (85); and,
b. the Downstream Rigid Hollowed Tubes (98-b) are never penetrated by the Incoming Laser Beam (18).

15. The Device (1) according to claim 1, characterized in that:
a. it is equipped with a Focusing Assembly (107), consisting of a plurality of Focusing Lenses (108), in fixed position with respect to the Rotation Axis (15) and the Impact Plane (48); and,
b. these Focusing Lenses (108) are positioned between the Rotating Optical Assembly (22) and the Impact Plane (48), and their Optical Axis (109) is perpendicular to the Impact Plane (48).

16. The Device (1) according to claim 15, characterized in that: its Focusing Assembly (107) is equipped with Cylindrical Focusing Lenses (110) (of cylindrical or semi-cylindrical type) having an Optical Cylinder Axis (111) substantially parallel to the Impact Plane (48).

17. The Device (1) according to claim 16, characterized in that its Focusing Assembly (107) consists of Cylindrical Focusing Lenses (110):
a. each configured to focus the Secondary Laser Beams (45) passing through them, (i) according to a narrow Rectangular Laser Impact Spot (112), (ii) that is to say whose Laser Spot Length (113) is at least twice greater than its Laser Spot Width (114), and, b. thus, defining a Rectangular Spot Axis (115) oriented according to the Laser Spot Length (113).

18. The Device (1) according to claim 1, characterized in that:
a. it comprises a Secondary Support (116), in a fixed position with respect to the Rotation Axis (15) and to the Impact Plane (48);
b. it comprises an Auxiliary Reflector Assembly (117, 117-a), composed of at least two (q) Auxiliary Mirrors (49, 118, 118-a-1, 118-a-2, 118-a-3), (i) each being in a fixed position between them and with respect to the Secondary Support (116), and, (ii) geometrically configured to deviate by successive reflections, the Auxiliary Laser Beams (119, 119-a-1, 119-a-2, 119-a-3, 119-a-4) of an Auxiliary Beam Collection (120, 120-a, 120-b, 120-c, 120-d), of which the first deflected beam (119-a-1) is made up of one of the Secondary Laser Beams (45, 45-21) emitted by the Rotating Optical Assembly (22); (iii) which are each successively impacted by one of the Auxiliary Laser Beams (119, 119-a-1, 119-a-2, 119-a-3) at an Auxiliary Reflection Point (121, 121-a-1, 121-a-2, 121-a-3) of this Auxiliary Mirror (118, 118-a-1, 118-a-2, 118-a-3) to constitute a new deviated Auxiliary Laser Beam of the Auxiliary Beams Collection (120, 120-a, 120-b, 120-c, 120-d), each time with a change in Beam Angular Direction (A) of this impacting Auxiliary Laser Beam (119, 119-a-1, 119-a-2, 119-a-3);
c. an Upstream Auxiliary Mirror (122, 118-a-1) of the Auxiliary Reflector Assembly (117, 117-a) is positioned in the path of a Secondary Laser Beam (45, 45-21); and is geometrically configured (i) to be impacted by this Secondary Laser Beam (45, 45-21), on its Auxiliary Reflection Point (121, 121-a-1), (ii) and to reflect it into a first deviated Auxiliary Laser Beam (119, 119-a-2) belonging to the Auxiliary Beams Collection (120, 120-a);
d. a Downstream Auxiliary Mirror (123, 118-a-3) of the Auxiliary Reflector Assembly (117, 117-a) is geometrically configured, (i) to face substantially both i) the last Auxiliary Laser Beam (119, 119-a-3) belonging to the Auxiliary Beams Collection (120, 120-a), and ii) the Control Area (3), and, (ii) to deflect this last Auxiliary Laser Beam (119, 119-a-3), according to a final Deflected Secondary Laser Beam (124, 119-a4, 124-a), which impacts, downstream of the Auxiliary Beams Collection (120, 120-a), a Deviated Impact Point (125, 125-a) of the Impact Plane (48) of the Control Area (3) adjacent to a Detection Point (36) of an EMAT type Electromagnetic Acoustic Transducer (34).

19. The Device (1) according to claim 18, characterized in that:
a. it comprises an Auxiliary Reflector Assembly (126, 126-1), consisting of at least two Auxiliary Reflector Assemblies (117, 117-a, 117-c),
b. said at least two Auxiliary Reflector Assemblies (117, 117-a, 117-c) are geometrically configured such that their at least two Deflected Secondary Laser Beams (124, 124-a, 124-c), (i) are parallel and arranged according to the same Deviated Secondary Beams Plane (127, 127-1), (ii) are substantially perpendicular to the Impact Plane (48), (iii) are arranged according to a Deflected Planar Array Of Secondary Beams (128, 128-1), and, (iv) impact a Deviated Impacts Set (129, 129-1) made of at least two distant Deviated Impact Points (125, 125-a, 125-c), arranged on a rectilinear Deviated Impacts Dotted Line (130, 130-1) of the Impact Plane (48) of the Control Zone (3).

20. The Device (1) according to claim 19, characterized in that:
a. it is equipped with a Focusing Assembly (107) consisting of Focusing Lenses (108), fixedly positioned with respect to the Rotation Axis (15) and to the Impact Plane (48);
and,
b. the Focusing Lenses (108) are geometrically configured into two groups, according to the positioning of their Optical Axes (109), including; (i) a first group made of Secondary Focusing Lenses (131), i) whose Secondary Optical Axis (132) coincides with the Secondary Axis (133) of a Secondary Laser Beam (45), coming from the Reflection Point (29) of a rotating Mirror (M), and ii) in this case it is fixed opposite the Rotation Axis (15), between the Virtual Reflection Cylinder (39) of revolution and the Impact Points (47) of this Secondary Laser Beam (45), and, iii) which is configured to focus this Secondary Laser Beam (45) on its Impact Point (47) of the Impacts Dotted Line (70), and, (ii) a second group made of Auxiliary Focusing Lenses (134), i) whose Auxiliary Optical Axis (135) is confused with the Auxiliary Axis (136) of a final Deflected Secondary Laser Beam (124), issued from the final Auxiliary Reflection Point (121, 121-b-3) of a Downstream Auxiliary Mirror (123, 118-b-3), and ii) in this case it is fixed with respect to the Rotation Axis (15), between the Virtual Reflection Cylinder (39) of revolution and the Deviated Impact Point (125, 125-b) of the Deflected Secondary Laser Beam (124, 124-a), and, iii) which is configured to focus this Deflected Secondary Laser Beam (124, 124-b) on its Deviated Impact Point (125, 125-b) of a Deviated Impacts Dotted Line (130, 130-2).

21. The Device (1) according to claim 20, characterized in that:
a. its Focusing Assembly (107) consists of Cylindrical Focusing Lenses (110), (i) fixed with respect to the Secondary Support (116), (ii) having an Optical Cylinder Axis (111) substantially parallel to the Impact Plane (48), (iii) each configured to focus a Secondary Laser Beam (45) or a Deflected Secondary Laser Beam (124) onto a Rectangular Laser Impact Spot (112) on the Impact Plane (48), along a Rectangular Spot Axis (115);
b. these Cylindrical Focusing Lenses (110) are geometrically configured in such a way that the Focusing Assembly (107) is divided into two groups: (i) on the one hand, a Longitudinal Focusing Collection (137), consisting of Longitudinal Cylindrical Focusing Lenses (138), that is to say whose Optical Cylinder Axis (111) is substantially longitudinal with respect to the Rotation Axis (15), which are configured to focus a light beam passing through them on a Longitudinal Rectangular Laser Impact Spot (139), and, (ii) on the other hand, a Transverse Focusing Collection (140), made up of Transverse Cylindrical Focusing Lenses (141), that is to say whose Optical Cylinder Axis (111) is substantially transverse to the Rotation Axis (15), which are configured to focus a light beam passing through them onto a Transverse Rectangular Laser Impact Spot (142).

22. The Device (1) according to claim 21, characterized in that:
a. it comprises both: (i) a Planar Array Of Secondary Beams (69), made up of Secondary Laser Beams (45, 45-11), (i) emitted by the Rotating Optical Assembly (22), (ii) which impact the Impact Points (47) belonging to the Impacts Dotted Line (70), and, (ii) at least one Deflected Planar Array Of Secondary Beams (128, 128-1, 128-2), consisting of Deflected Secondary Laser Beams (124, 124-a-21, 124-b-22, 124-c-23, 124-d-24), i) of an Auxiliary Reflector Assembly (126, 126-1, 126-2), ii) which impact the Deviated Impact Points (125, 125-a-21, 125-b-22, 125-c-23, 125-d-24) belonging to at least one Deviated Impacts Dotted Line (130, 130-1, 130-2);
b. the Longitudinal Cylindrical Focusing Lenses (138), and the Transverse Cylindrical Focusing Lenses (141) are positioned in complementary and exclusive way in two groups, such that: (i) a first group (110-1) focuses the Planar Array Of Secondary Beams (69) on its Impacts Dotted Line (70), i) only according to Longitudinal Rectangular Laser Impact Spots (139), or ii) only according to Transverse Rectangular Laser Impact Spots (142); and, (ii) alternatively, and exclusively from the previous one, a second group (110-2) focuses the Deflected Planar Array Of Secondary Beams (128, 128-1, 128-2) on a Deviated Impacts Dotted Line (130, 130-1, 130-2), i) only according to Transverse Rectangular Laser Impact Spots (142), or ii) only according to Longitudinal Rectangular Laser Impact Spots (139).

23. The Device (1) according to claim 1, characterized in that:
a. its Sensor Assembly (33) is composed of Directional EMATs (143), of the type presenting a Privileged Directional Sensing Orientation (144) of the Induced Signals (11) generated by the interaction of Mechanical Vibrations (8) with Surface Discontinuities (12) and Sub-surface Discontinuities (13);
b. its Sensor Assembly (33) is configured so as to be divided into two groups, (i) on the one hand a Collection of Longitudinal Sensors (145), made up of Longitudinal EMATs (146, 146-T, 146-D), that is to say with a Privileged Directional Sensing Orientation (144) in a longitudinal direction with respect to the Rotation Axis (15), and, (ii) on the other hand, a Collection of Transverse Sensors (147), made up of Transverse EMATs (148, 148-T, 148-D), that is to say with a Privileged Directional Sensing Orientation (144) in a transverse direction with respect to the Rotation Axis (15);
c. the Transverse Rectangular Laser Impact Spots (142, 15-a-21, 125-b-22, 125-c-23, 125-d-24) are (in number) predominantly located between two Longitudinal EMATs (146); and,
d. the Longitudinal Rectangular Laser Impact Spots (139, 47-11) are (in number) predominantly located in the vicinity and above or below the Transverse EMATs (148), with reference to a height positioning orientation taken perpendicular to the Rotation Axis (15).

24. The Device (1) according to claim 20, characterized in that its Rotating Optical Assembly (22) is geometrically configured so that:
a. it comprises both: (i) a Planar Array Of Secondary Beams (69), (i) made up of Secondary Laser Beams (45, 45-11), (ii) which impact the Impact Points (47) of the main Impacts Dotted Line (70), and (ii) two Deflected Planar Arrays Of Secondary Beams (128, 128-1, 128-2), i) made up of two groups of Deflected Secondary Laser Beams (124-a, 124-c) and (124-b, 124-d), ii) issued from two Auxiliary Reflector Assemblies (126, 126-1, 126-2), iii) which impact two distant auxiliaries Deviated Impacts Dotted Lines (130, 130-1, 130-2); and,
b. the main Impacts Dotted Line (70) and the two auxiliary Deviated Impacts Dotted Lines (130, 130-1, 130-2) are all three parallel to the Rotation Axis (15) and distant from each other; and,
c. the two Deviated Impacts Dotted Lines (130, 130-1, 130-2) are located on either side, which is to say above and below the main Impacts Dotted Line (70), referring to a height positioning orientation taken perpendicular to the Rotation Axis (15).

25. The Device (1) according to claim 24, characterized in that its Rotating Optical Assembly (22) is geometrically configured so that:
a. its main Impacts Dotted Line (70) is formed of Longitudinal Rectangular Laser Impact Spots (139); and,
b. its two auxiliary Deviated Impacts Dotted Lines (130, 130-1, 130-2) are formed of Transverse Rectangular Laser Impact Spots (142, 125-a-21, 125-b-22, 125-c-23, 125-d-24).

26. The Device (1) according to claim 25, characterized in that its Rotating Optical Assembly (22) is geometrically configured so that:
a. its Longitudinal EMATs (146, 146-T, 146-D) are predominantly (in number) (i) aligned on either side and alternately opposite the main Impacts Dotted Line (70), and, (ii) positioned longitudinally next to a Transverse Rectangular Laser Impact Spot (142, 125-a-21, 125-b-22, 125-c-23, 125-d-24) of one of the two Deviated Impacts Dotted Lines (130, 130-1, 130-2); and,
b. its Transverse EMATs (148, 148-T, 148-D) are predominantly (in number) positioned and aligned alternately above and/or below the Longitudinal EMATs (146, 146-T, 146-D), making reference to a height positioning orientation taken in a direction perpendicular to the Rotation Axis (15).

27. The Device (1) according to claim 1, further comprising: (a) Means Of Angular Position Monitoring (149) of the single Rotating Shaft (14), and therefore of the Monolithic Rotating Optical Assembly (22) in rotation with respect to the Rotation Axis (15), (i) connected to the single Rotating Shaft (14); (b) Means Of Laser Pulses Monitoring And Timing (150), (i) electrically connected to the Incoming Laser Source (16), and (ii) configured to control and/or clock the generation of laser pulses by the Incoming Laser Source (16); (c) Means of Motor Rotation Timing (151), (i) electrically connected to the Drive Motor (24-a); (d) a Synchronized Laser Pulses And Rotation Timing Processor (152), (i) electrically connected to the Means Of Angular Position Monitoring (149) of the Rotating Shaft (14), and, (ii) electrically connected to the Means of Motor Rotation Timing (151), to continuously receive the angular position of the Rotating Shaft (14); this Device (1) being characterized in that the Synchronized Laser Pulses And Rotation Timing Processor (152) is configured:
a. either in Motor Monitoring Mode (153), (i) to electrically control the Means of Motor Rotation Timing (151), (ii) depending on the timing of the laser pulses generated by the Incoming Laser Source (16), (iii) in order to successively position the axial angular position of the Rotating Optical Assembly (22), (iv) such that the Pulses Number Of Mirror Impacts (NIM) of the pulses of the Incoming Laser Beam (18) impacting each of the rotating Mirrors (M, M1, . . . , M20), in the vicinity of its Reflection Point (29) of the rotating Helical Dotted Line (43), is constant (for example NIM=2);
b. or, either in Pulses Monitoring Mode (154), (i) to electrically control the Means Of Laser Pulses Monitoring And Timing (150), (ii) depending on the timing of the axial angular position of the Rotating Optical Assembly (22), received continuously from the Means Of Angular Position Monitoring (149), in order to successively adapt the timing of the pulses of the Incoming Laser Beam (18), (iii) such that the Pulses Number Of Mirror Impacts (NIM) of the pulses of the Incoming Laser Beam (18) impacting each of the rotating Mirrors (M, M1, . . . , M20), in the vicinity of its Reflection Point (29) of the rotating Helical Dotted Line (43), is constant (for example NIM=2).
